(19) United States
(12) Patent Application Publication
(10) Pub. No.: US 2019/0129675 A1
(43) Pub. Date: May 2, 2019

(54) PLANT MANAGEMENT SYSTEM, PLANT MANAGEMENT METHOD, PLANT MANAGEMENT APPARATUS, AND PLANT MANAGEMENT PROGRAM

(71) Applicant: NEC CORPORATION, Tokyo (JP)

(72) Inventor: Katsuhiro OCHIAI, Tokyo (JP)

(73) Assignee: NEC CORPORATION, Tokyo (JP)

(21) Appl. No.: 16/089,802

(22) PCT Filed: Feb. 20, 2017
(86) PCT No.: PCT/JP2017/006085

§ 371 Date: Sep. 28, 2018

(30) Foreign Application Priority Data
Mar. 30, 2016 (JP) 2016-068249

(51) Int. Cl. G06F 3/147; G06Q 10/06

(52) U.S. Cl. CPC G06F 3/147; H04B 1/3827; G06Q 10/06316

(57) ABSTRACT

This invention is directed to a plant management system that efficiently supports the on-site work of an operator who checks or maintains a structure such as a plant. The plant management system comprises a position acquirer that acquires a position of a terminal, a sensor specifier that specifies a sensor in accordance with the position of the terminal, and a sensor information acquirer that acquires sensor information concerning the specified sensor; and a presenter that presents the sensor information to an operator by superimposing or projecting the sensor information in association with a target to be measured by the specified sensor. Here, the presenter includes a superimposing display unit or a projection device.

### CROSS REFERENCE TO RELATED APPLICATIONS

This application is based upon and claims the benefit of priority from Japanese patent application No. 2016-068249, filed on Mar. 30, 2016, the disclosure of which is incorporated herein in its entirety by reference.

### TECHNICAL FIELD

The present invention relates to a plant management system, a plant management method, a plant management apparatus, and a plant management program.

### BACKGROUND ART

In the technical field, patent literature 1 discloses a technique of displaying an image of an object and a virtual control panel including display of a sensor output value on a head mounted display of a user in a superimposed manner and making the user to input an operation from the virtual control panel.

### CITATION LIST

### Patent Literature

Patent literature 1: U.S. Patent Application Publication No. 2006/0241792

### SUMMARY OF THE INVENTION

### Technical Problem

In the technique described in the above literature, however, the association between the environment of the current position of the user and the sensor output value displayed on the virtual control panel is not strong. For this reason, when the technique is applied to on-site work support for an operator who checks or maintains a structure such as a plant, it is impossible to efficiently support the operator.

The present invention enables to provide a technique of solving the above-described problem.

### Solution to Problem

One example aspect of the present invention provides a plant management system comprising:

a position acquirer that acquires a position of a terminal;

a sensor specifier that specifies a sensor in accordance with the position of the terminal;

a sensor information acquirer that acquires sensor information concerning the specified sensor; and

a presenter that presents the sensor information to an operator by superimposing or projecting the sensor information in association with a target to be measured by the specified sensor.

Another example aspect of the present invention provides a plant management method comprising:

acquiring a position of a terminal;

specifying a sensor in accordance with the acquired position;

acquiring sensor information concerning the specified sensor; and

presenting the sensor information to an operator by superimposing or projecting the sensor information in association with a target to be measured by the specified sensor.

Still other example aspect of the present invention provides a plant management apparatus comprising:

a position acquirer that acquires a position of a terminal carried by an operator;

a sensor specifier that specifies a sensor in accordance with the acquired position;

a sensor information acquirer that acquires sensor information concerning the specified sensor; and

an instructor that instructs to present the sensor information to the operator by superimposing or projecting the sensor information in association with a target to be measured by the specified sensor.

Still other example aspect of the present invention provides a plant management program for causing a computer to execute a method comprising:

displaying a list of tasks to be performed by an operator on a terminal which is carried by the operator, after login from the terminal;

acquiring a position of the terminal; and

instructing to present sensor information concerning a sensor specified in accordance with the acquired position to the operator by superimposing or projecting the sensor information in association with a target to be measured by the specified sensor.

Still other example aspect of the present invention provides a plant management program for causing a computer to execute a method comprising:

acquiring a position of a terminal which is carried by an operator, after login from the terminal;

specifying a sensor in accordance with the acquired position;

acquiring sensor information concerning the specified sensor; and

generating presentation information to be presented to the operator by superimposing or projecting the sensor information in association with a target to be measured by the specified sensor.

Still other example aspect of the present invention provides a plant management program for causing a computer to execute a method comprising:

acquiring sensor information concerning a sensor specified in accordance with a position of a terminal which is carried by an operator, after login from the terminal;

acquiring associated information acquired by the terminal in association with the specified sensor; and

accumulating the sensor information and the associated information in an accumulator in association with each other.

### Advantageous Effects of Invention

According to the present invention, it is possible to efficiently support the on-site work of an operator who checks or maintains a structure such as a plant.

### BRIEF DESCRIPTION OF DRAWINGS

FIG. 1 is a block diagram showing the arrangement of a plant management system according to the first example embodiment of the present invention;

FIG. 2A is a view showing the operation outline of a plant management system according to the second example embodiment of the present invention;

FIG. 2B is a view showing a presentation example on work-site in the plant management system according to the second example embodiment of the present invention;

FIG. 3 is a view showing the operation outline of a plant management system according to an existing technique;

FIG. 4A is a block diagram showing a functional arrangement of the plant management system according to the second example embodiment of the present invention;

FIG. 4B is a block diagram showing another functional arrangement of the plant management system according to the second example embodiment of the present invention;

FIG. 4C is a block diagram showing still another functional arrangement of the plant management system according to the second example embodiment of the present invention;

FIG. 5A is a block diagram showing the hardware arrangement of the plant management system according to the second example embodiment of the present invention;

FIG. 5B is a block diagram showing the software configuration of the plant management system according to the second example embodiment of the present invention;

FIG. 5C is a view showing the workflow of the plant management system according to the second example embodiment of the present invention;

FIG. 6 is a sequence chart showing the operation procedure of the plant management system according to the second example embodiment of the present invention;

FIG. 7A is a block diagram showing the functional arrangement of an alarm transmitter/receiver according to the second example embodiment of the present invention;

FIG. 7B is a view showing the arrangement of an alarm determination table according to the second example embodiment of the present invention;

FIG. 7C is a flowchart showing the operation procedure of the alarm transmitter/receiver according to the second example embodiment of the present invention;

FIG. 8A is a block diagram showing the functional arrangement of a workflow controller according to the second example embodiment of the present invention;

FIG. 8B is a view showing the arrangement of a workflow activation table according to the second example embodiment of the present invention;

FIG. 8C is a flowchart showing the operation procedure of the workflow controller according to the second example embodiment of the present invention;

FIG. 9A is a block diagram showing the functional arrangement of a data accumulator according to the second example embodiment of the present invention;

FIG. 9B is a view showing the arrangement of a data accumulation table according to the second example embodiment of the present invention;

FIG. 9C is a flowchart showing the operation procedure of the data accumulator according to the second example embodiment of the present invention;

FIG. 10 is a view showing the workflow of a work according to the second example embodiment of the present invention;

FIG. 11A is a view showing an operation outline of a plant management system according to the third example embodiment of the present invention;

FIG. 11B is a view showing another operation outline of the plant management system according to the third example embodiment of the present invention;

FIG. 12A is a block diagram showing a functional arrangement of the plant management system according to the third example embodiment of the present invention;

FIG. 12B is a block diagram showing another functional arrangement of the plant management system according to the third example embodiment of the present invention;

FIG. 13 is a block diagram showing the hardware arrangement of the plant management system according to the third example embodiment of the present invention;

FIG. 14 is a sequence chart showing the operation procedure of the plant management system according to the third example embodiment of the present invention;

FIG. 15 is a view showing the workflow of a work according to the third example embodiment of the present invention;

FIG. 16 is a view showing the first presentation example on work-site in a plant management system according to the fourth example embodiment of the present invention and a corresponding workflow;

FIG. 17 is a view showing the second presentation example on work-site in the plant management system according to the fourth example embodiment of the present invention and a corresponding workflow;

FIG. 18 is a view showing the third presentation example on work-site in the plant management system according to the fourth example embodiment of the present invention and a corresponding workflow;

FIG. 19 is a view showing the fourth presentation example on work-site in the plant management system according to the fourth example embodiment of the present invention and a corresponding workflow;

FIG. 20 is a view showing the fifth presentation example on work-site in the plant management system according to the fourth example embodiment of the present invention and a corresponding workflow;

FIG. 21 is a view showing the sixth presentation example on work-site in the plant management system according to the fourth example embodiment of the present invention and a corresponding workflow;

FIG. 22 is a view showing the seventh presentation example on work-site in the plant management system according to the fourth example embodiment of the present invention and a corresponding workflow;

FIG. 23 is a view showing the eighth presentation example on work-site in the plant management system according to the fourth example embodiment of the present invention and a corresponding workflow;

FIG. 24 is a view showing the ninth presentation example on work-site in the plant management system according to the fourth example embodiment of the present invention and a corresponding workflow;

FIG. 25 is a view showing the 10th presentation example on work-site in the plant management system according to the fourth example embodiment of the present invention and a corresponding workflow;

FIG. 26 is a view showing the 11th presentation example on work-site in the plant management system according to the fourth example embodiment of the present invention and a corresponding workflow;

FIG. 27 is a view showing the 12th presentation example on work-site in the plant management system according to the fourth example embodiment of the present invention and a corresponding workflow;

FIG. 28 is a view showing the operation outline of a plant management system according to the fifth example embodiment of the present invention; and

FIG. 29 is a block diagram showing the hardware arrangement of the plant management system according to the fifth example embodiment of the present invention.

### DESCRIPTION OF EXAMPLE EMBODIMENTS

Example embodiments of the present invention will now be described in detail with reference to the drawings. It should be noted that the relative arrangement of the components, the numerical expressions and numerical values set forth in these example embodiments do not limit the scope of the present invention unless it is specifically stated otherwise.

Note that a term “sensor information” used in this specification not only indicates measurement information detected by a sensor particularly shown in a drawing and the time-series data of the information but also includes, for example, the part of a setting target in a plant or the like in which the sensor is set, such as the name and characteristics of the sensor, or the unit information of sensor data. In addition, the sensor information may also include the type of the sensor, the format of data output from the sensor, firmware provided in the sensor, and the like. These pieces of information can also achieve the effect of the example embodiment.

### First Example Embodiment

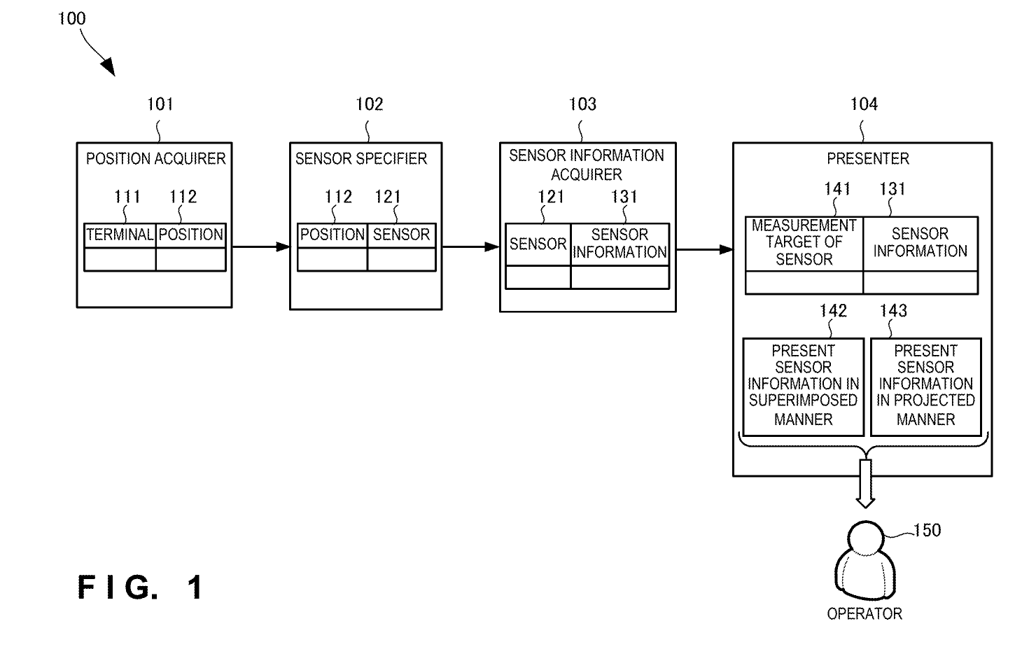

A plant management system 100 according to the first example embodiment of the present invention will be described with reference to FIG. 1. The plant management system 100 is a system that supports the on-site work of an operator who checks or maintains a plant or the like.

As shown in FIG. 1, the plant management system 100 includes a position acquirer 101, a sensor specifier 102, a sensor information acquirer 103, and a presenter 104. The position acquirer 101 acquires a position 112 of a terminal 111. The sensor specifier 102 specifies a sensor 121 in accordance with the position 112 of the terminal. The sensor information acquirer 103 acquires sensor information 131 concerning the specified sensor 121. The presenter 104 superimposes (142) or projects (143) the sensor information 131 in association with a measurement target 141 of the specified sensor 121, and presents it to an operator 150.

According to this example embodiment, the sensor information of the sensor on the work site is presented to the operator, thereby efficiently supporting the on-site work of the operator who checks or maintains a structure such as a plant.

### Second Example Embodiment

A plant management system according to the second example embodiment of the present invention will be described next. The plant management system according to this example embodiment presents sensor information associated with a site on a terminal (HMD), and acquires associated information of the sensor from an operator and accumulates the information, thereby efficiently supporting the on-site work of the operator who checks or maintains a plant or the like.

For example, in this example embodiment, using AR (Augmented Reality), sensor information is displayed in a superimposed manner in association with the measurement target, that is, the installation position of a sensor specified at a position acquired using a GPS (Global Positioning System) as a site. Note that in a place where GPS positioning cannot be performed, autonomous positioning like car navigation in a tunnel may be combined with the GPS. In addition, the position may be acquired by analyzing an image captured by a camera. Note that the sensor may be specified from abnormal sensors determined by an abnormal sensor determiner, or the sensor may be specified in accordance with a position at which an abnormality is detected.

Furthermore, in this example embodiment, associated information associated with a specified sensor, which is acquired by the terminal based on the operation of the operator, and the sensor information are accumulated in association with each other, and the operation state of the measurement target is predicted based on the association between the accumulated sensor information and the associated information.

Note that as the terminal in this example embodiment, for example, an HMD (Head Mounting Display), a portable telephone, a smartphone, a tablet, or the like is used. The terminal may be an autonomous movable robot or drone capable of acquiring the information of the site. In this case, a designated point or direction is indicated to the robot or drone, and sound recording or video capturing is instructed. When the robot or drone is used, the information of observation or experience of the operator is indirect.

<<Existing Plant Management System>>

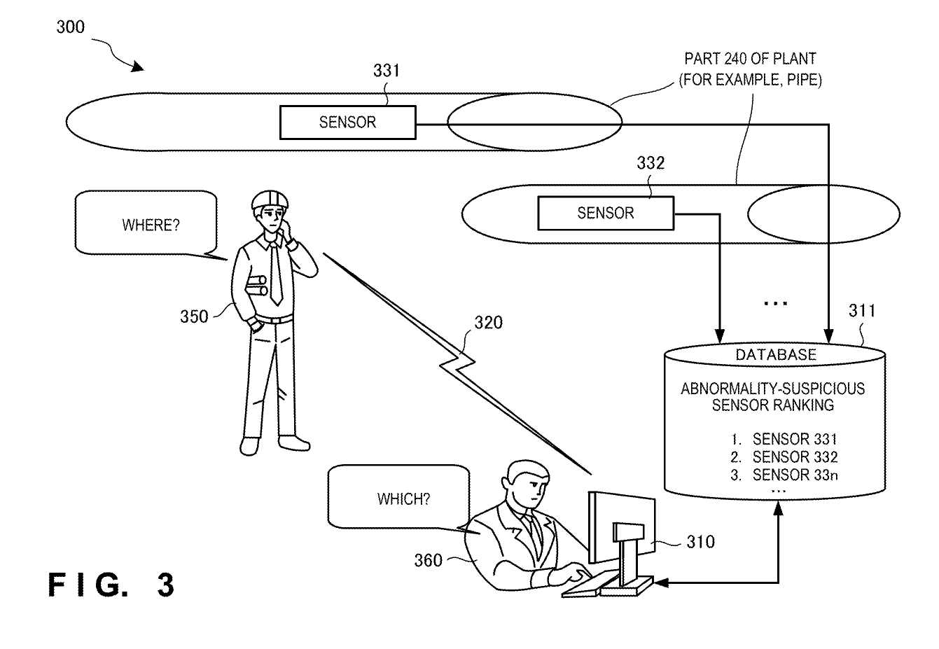

First, to explicitly show the features of this example embodiment, the operation outline of a plant management system 300 according to an existing technique will be described with reference to FIG. 3.

The plant management system 300 is a system configured to monitor or maintain a structure such as a plant. For example, in the management center of the plant management system 300, various kinds of sensors 331 and 332 are arranged to collect pieces of sensor information. The pieces of sensor information are accumulated in a database 311, and it is monitored whether an abnormality or fault exists in the operation of the plant or not. Note that if an abnormality is recognized, a manager 360 instructs from a management center terminal 310 to analyze the sensor information accumulated in the database 311. For example, a ranking of suspicious sensors as the cause of the abnormality may be generated, and an operator on the corresponding site may be instructed to do observation. If an abnormality or fault is found, or if an abnormality or fault is predicted by analysis of the sensor information, the manager 360 instructs the site to perform a maintenance operation from the management center terminal 310.

On the other hand, an operator 350 on work-site periodically observes a part 240 of the plant that the operator is in charge of and transmits the information to the management center via a communication 320 using a telephone or the like. At the time of abnormality recognition, the operator 350 inspects the part 240 of the plant that the operator is in charge of in accordance with an instruction of the manager 360 from the management center terminal 310. Upon receiving a maintenance operation instruction by the manager 360 from the management center terminal 310, the operator 350 executes the corresponding maintenance operation.

However, since the inspection instruction to the operator 350 on work-site is based on the collected sensor information, it is difficult to narrow down the point or cause of the abnormality. In addition, the observation, check, or inspection by the operator 350 on work-site is performed in accordance with an established instruction from the management center. Hence, the pieces of sensor information from the sensors 331 and 332 and the observation and sense of the operator 350 on work-site are combined with each other, and it is difficult to obtain more useful information for abnormality diagnosis or fault diagnosis selected based on the degree of importance.

That is, since the point or cause of the abnormality is narrowed down based on only the data collected from the sensors, information that does not appear in the data cannot be used for analysis, and details such as the portion to inspect cannot be known even on work-site. It is therefore impossible to correctly know a point that should be monitored in a large-scale plant and specify the cause of an abnormality by comprehensively determining peripheral situations on work-site.

<<Plant Management System of this Example Embodiment>>

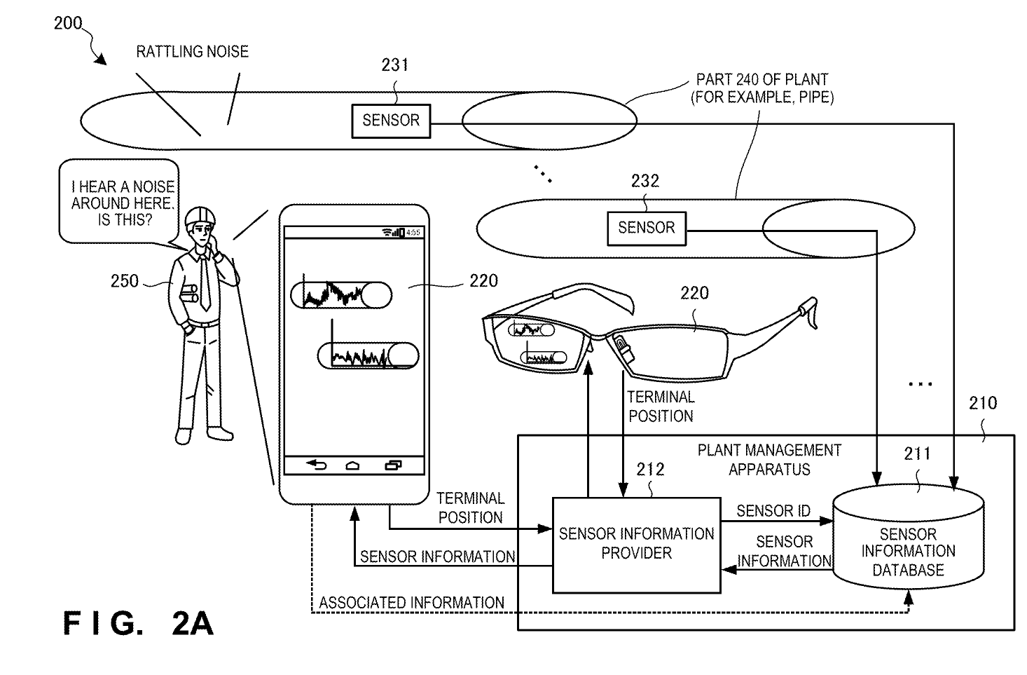

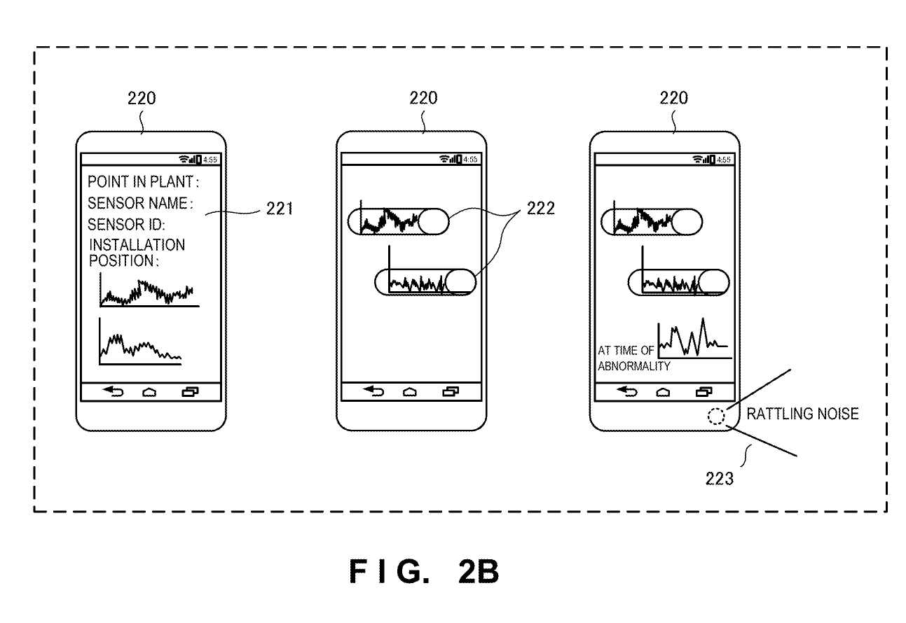

The arrangement and operation of a plant management system 200 according to this example embodiment will be described with reference to FIGS. 2A, 2B, and 4A to 6.

(Operation Outline)

FIG. 2A is a view showing the operation outline of the plant management system 200 according to this example embodiment.

The plant management system 200 is a system configured to monitor or maintain a structure such as a plant. For example, the management center of the plant management system 200 includes a plant management apparatus 210 including a sensor information database 211 and a sensor information provider 212. Pieces of sensor information from sensors 231 and 232 configured to detect the state of the plant and sensor identifiers (to be referred to as sensor IDs hereinafter) are accumulated in the sensor information database 211 in association with each other. In addition, pieces of associated information associated with the sensors, which are acquired by a terminal 220 carried by an operator 250, may also be accumulated in the sensor information database 211 in association with the sensor information. The associated information includes an image (or video) of the plant captured by the terminal 220, a sound generated by the plant and recorded by the terminal 220, information of the on-site situation input by the operator 250 to the terminal 220, and the like.

Here, upon receiving the position information of the terminal 220 carried by the operator 250 on the work site that the operator is in charge of, the sensor information provider 212 of the plant management apparatus 210 selects a sensor at a sensor position installed in a plant as the observation or inspection target of the operator 250 based on the position information of the terminal 220. The sensor information provider 212 acquires sensor information currently under detection or the history of previously detected sensor information from the sensor information database 211 based on the sensor ID and presents the sensor information from the terminal 220 to the operator 250. The information presented from the terminal 220 to the operator 250 may include the above-described associated information to promote support of the work of the operator 250. Additionally, to promote support of the work of the operator 250, the sensor information or associated information is preferably superimposed on a 3D image of the plant generated by the plant management apparatus 210 and presented, or superimposed on an image captured by the camera of the terminal 220 and presented. If the 3D image of the plant is an image through which the internal structure of the plant is visible, the work target of the operator 250 on work-site can be indicated more exactly. In addition, when the 3D plant image through which the internal structure is visible is superimposed on a captured moving image including the operator 250 as well, the work target position (for example, check position/inspection position) can be guided.

Note that in FIG. 2A, for example, when the operator 250 who notices a “gakon, gakon --” (ratting noise) in the part 240 of the plant approaches the noise generation point, the plant management apparatus 210 selects the sensor 231 based on the position information of the terminal (smartphone) 220 and causes the terminal (smartphone) 220 to present sensor information detected by the sensor 231 to the operator 250. Note that the presented information may be the sensor information of the sensor itself, information processed by the plant management apparatus 210, or an analysis result obtained when the plant management apparatus 210 makes analyses with reference to a history accumulated in the sensor information database 211. For example, as the analysis result, information such as the cause of noise generation, a target to be observed or inspected, or a target to be adjusted for which abnormality occurrence (failure or fault) is predicted. To analyze such noise generation, the sensor information provider 212 preferably presents a reference sound or previous recording sound from the terminal (smartphone) 220 to the operator 250. If the color of the plant, the color of the installation position, or information corresponding to another one of five senses such as a smell is preferably presented if the information can be presented from the terminal (smartphone) 220 to the operator 250.

On the other hand, for example, when the operator 250 approaches the sensor 232 in a periodical inspection, an HMD that is an example of the terminal 220 selects the sensor 232 based on the position information from the terminal (HMD) 220, and the sensor information detected by the sensor 232 is presented from the terminal (HMD) 220 to the operator 250. The operator 250 can improve the accuracy and quality of the inspection while confirming the position of the sensor 232 in the plant and the sensor information detected by the sensor 232. In addition, an inspection report with the improved accuracy and quality from the operator 250 leads to correct plant monitoring and failure prediction by the plant management apparatus 210.

As described above, in the plant management system 200 according to this example embodiment, the sensor information from the sensors 231 and 232 and the observation and sense of the operator 250 on work-site are combined with each other, and more useful information for abnormality diagnosis or fault diagnosis selected based on the degree of importance can be obtained. That is, since a point or cause of an abnormality is narrowed down based on data collected from the sensors and associated information acquired by the operator on work-site, information that does not appear in the data can be used for analysis, and details such as the portion to inspect on work-site becomes clearer. It is therefore possible to correctly know a point that should be monitored in a large-scale plant and specify or predict the cause of an abnormality by comprehensively determining peripheral situations on work-site.

Note that in the above description, an example in which the sensor information of the sensor 231 is presented on the terminal (smartphone) 220, and the sensor information of the sensor 232 is presented on the terminal (HMD) 220 has been described. However, a plurality of pieces of sensor information of a plurality of sensors 231, 232, . . . installed within a predetermined range from the terminal 220 may be presented. Alternatively, pieces of sensor information selected in the ascending order of the distance of the sensor from the terminal 220 or in the descending order of the degree of importance of the sensor may be presented.

(Presentation on Work-Site)

FIG. 2B is a view showing a presentation example on work-site in the plant management system 200 according to this example embodiment. Note that the presentation example on work-site is not limited to that in FIG. 2B, and any other more effective combination is also possible.

In the left view of FIG. 2B, sensor information is presented on a display screen 221 of the terminal 220 based on the position information of the terminal 220 together with a point in a plant, a sensor name, a sensor ID, a sensor installation position, and the like.

In the central view of FIG. 2B, sensor information superimposed on a captured image or a 3D generation image 222 of the plant including the sensor installation position is presented on the display screen of the terminal 220 based on the position information of the terminal 220. Note that the image on which the sensor information is superimposed may be a still image or a moving image. In the case of the moving image, processing of preventing a blur is preferably performed.

In the right view of FIG. 2B, the sensor information of the sensor is presented on the display screen of the terminal 220 based on the position information of the terminal 220. Simultaneously, sensor information at the time of an abnormality and a rating noise 223 generated at the time of the abnormality are presented.

(Functional Arrangement)

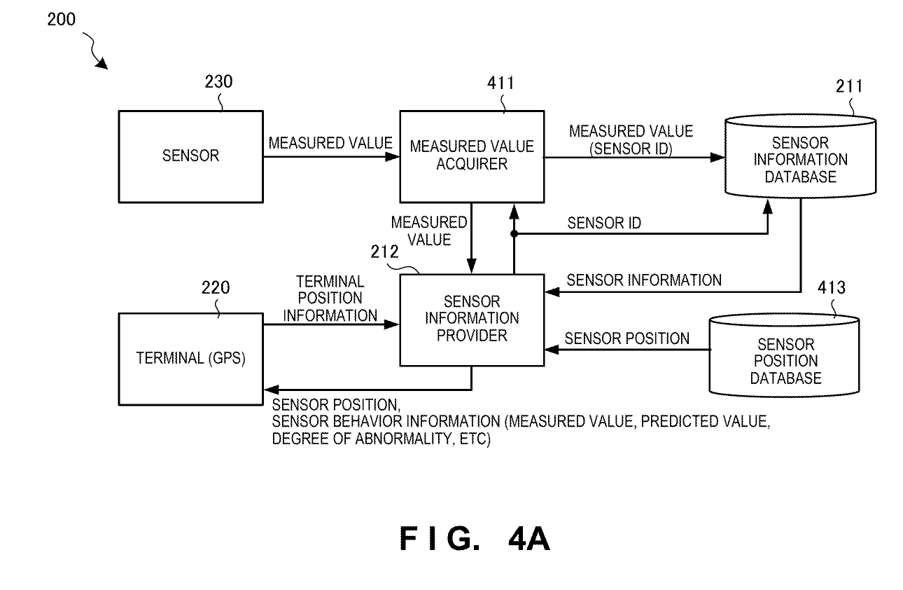

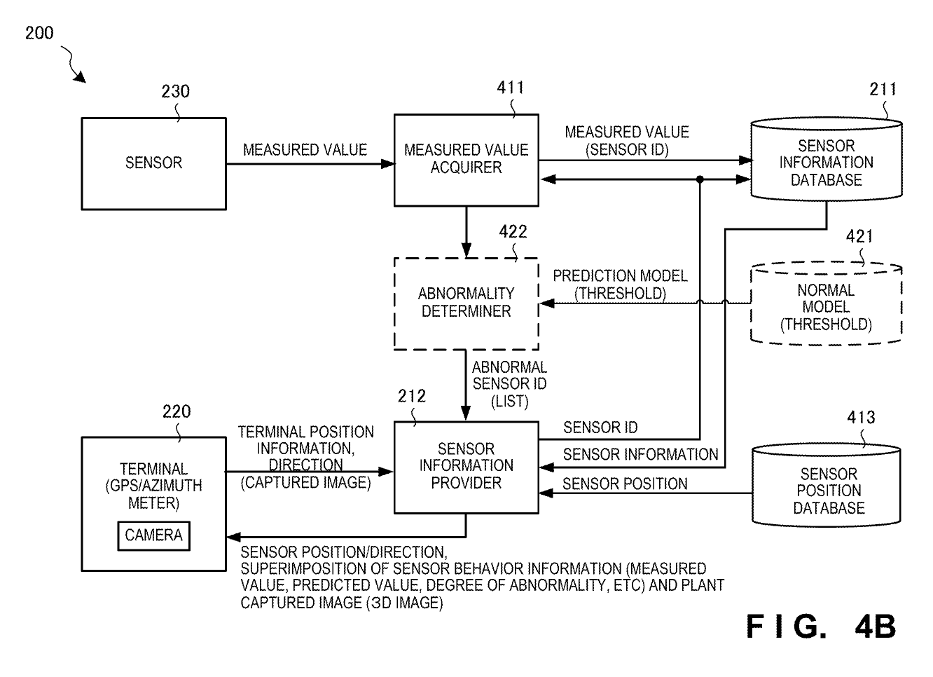

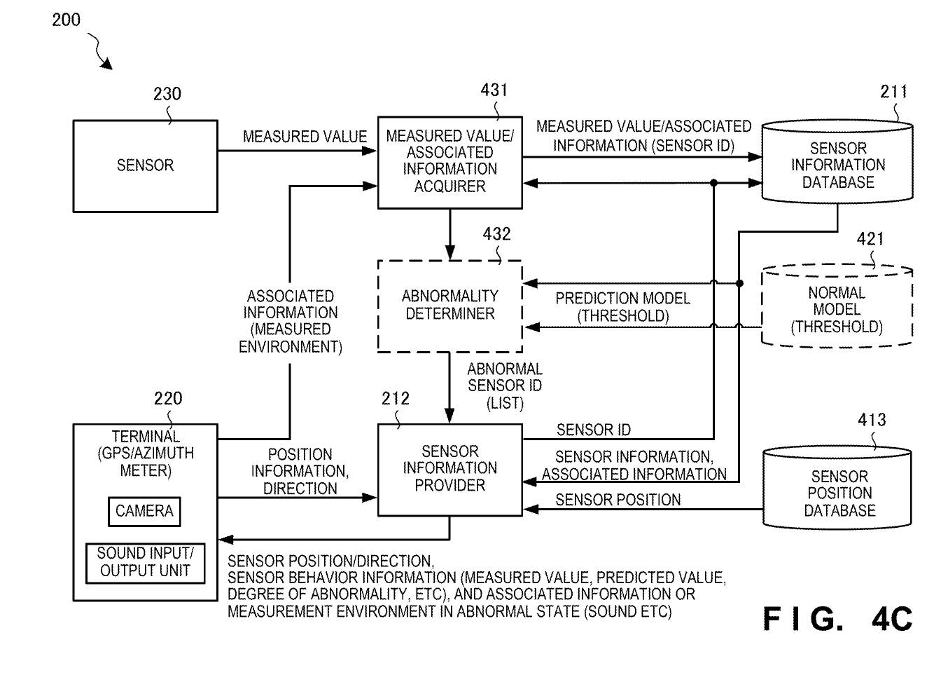

Three typical functional arrangement examples of the plant management system 200 according to this example embodiment will be described below with reference to FIGS. 4A to 4C. Note that the functional arrangements of the plant management system 200 according to this example embodiment are not limited to those in FIGS. 4A to 4C, and it is possible to combine the functional arrangements, delete a function, add another function, merge a plurality of functions, divide one function, or merge some functions. These functional arrangements also have the same effect.

FIG. 4A is a block diagram showing a functional arrangement of the plant management system 200 according to this example embodiment. FIG. 4A shows an example of the simplest functional arrangement in which the sensor information of a sensor selected based on the position information of the terminal 220 carried by the operator 250 on work-site is presented from the terminal 220 to the operator 250 on work-site. Note that the same reference numerals as in FIG. 2A denote the same constituent elements in FIG. 4A, and a detailed description thereof will be omitted.

The plant management system 200 includes a sensor 230 installed in the plant, a measured value acquirer 411 that acquires the measured value from the sensor 230, the sensor information database 211 that accumulates sensor information including the measured value in association with a sensor ID, and a sensor position database 413 that stores the sensor position of each sensor. The plant management system 200 also includes the terminal 220 having a position determination function such as a GPS and carried by the operator 250, and the sensor information provider 212 that receives terminal position information from the terminal 220 and causes the terminal 220 to present sensor information corresponding to the terminal position information to the operator 250.

In the arrangement shown in FIG. 4A, the measured value from the sensor 230 is acquired by the measured value acquirer 411 and accumulated in the sensor information database 211 in association with the sensor ID. On the other hand, the terminal 220 carried by the operator 250 acquires the terminal position information on work-site using the GPS function or the like and notifies the sensor information provider 212 of it. The sensor information provider 212 acquires the sensor position of each sensor from the sensor position database 413 based on the notified terminal position information, and selects, for example, sensors within a predetermined distance range for the terminal position. Next, the sensor information provider 212 transmits the sensor ID of each acquired sensor to the measured value acquirer 411 and the sensor information database 211, and acquires information from the measured value acquirer 411 in a case in which the current measured value is presented on the terminal 220 or acquires information from the sensor information database 211 in a case in which the history of sensor information is presented on the terminal 220. Then, the sensor information provider 212 presents the acquired sensor information of the selected sensor on the terminal 220 carried by the operator 250 on work-site. The presented sensor information may include the sensor position and sensor behavior information (a measured value, a predicted value, the degree of an abnormality, and the like).

FIG. 4B is a block diagram showing another functional arrangement of the plant management system 200 according to this example embodiment. FIG. 4B shows an example of the functional arrangement using the AR technology in which the sensor information of a selected sensor is superimposed at a sensor position in an image captured by the camera of the terminal 220 based on the position information of the terminal 220 carried by the operator 250 on work-site, and presented from the terminal 220 to the operator 250 on work-site. Note that the same reference numerals as in FIG. 4A denote the same constituent elements in FIG. 4B, and a repetitive description thereof will be omitted. Even in a case in which the sensor information is superimposed on a 3D plant image generated by the plant management system 200, the functional arrangement is the same except that the camera captured image changes to the 3D plant image.

The terminal 220 of the plant management system 200 includes a camera. In addition, the plant management system 200 includes, as options, a storage unit 421 that stores a normal model or threshold of the measured value of a sensor, and an abnormality determiner 422 that determines an abnormality of the measured value based on the comparison between the measured value of the sensor and the normal model or threshold.

In the arrangement shown in FIG. 4B, the terminal 220 carried by the operator 250 acquires the terminal position information on work-site using the GPS function or the like. In addition, the terminal 220 captures the plant by the camera and notifies the sensor information provider 212 of the terminal position information and the plant image. The sensor information provider 212 selects the sensor, as in FIG. 4A, based on the notified terminal position information, and acquires the sensor information based on the sensor ID. Then, the sensor information provider 212 superimposes the acquired sensor information of the selected sensor on the plant image captured by the camera of the terminal 220 on work-site and presents the sensor information on the terminal 220 carried by the operator 250 on work-site.

Note that the plant image is not limited to the image captured by the camera of the terminal 220 on work-site. A 3D plant image of a plant portion corresponding to the position information of the terminal 220 may be generated from the three-dimensional information of the plant structure, and the acquired sensor information of the selected sensor may be superimposed on the 3D plant image and presented on the terminal 220 carried by the operator 250 on work-site. In the case of the 3D plant image, preferably, directions are acquired from the terminal 220, the 3D plant image is deformed into a 3D plant image from an angle easy for the operator 250 to determine, and the sensor information is superimposed.

If the abnormality determiner 422 as an option is included, the list of abnormal sensor IDs estimated as abnormal is generated based on the comparison between the measured value of the sensor and the normal model or threshold acquired from the storage unit 421 and notified to the sensor information provider 212. Note that the list of the abnormal sensor IDs preferably includes sensors listed in the descending order of the possibility of abnormality or in the descending order of the degree of importance. In this arrangement, the sensor information provider 212 may present not the sensor selected based on the notified terminal position information but the position information and the sensor information of the closest sensor within the predetermined range from the position information of the terminal 220 in the abnormal sensor list and urge the operator 250 to do the next work. Use of the determination result by the abnormality determiner 422 is not limited to the above-described example.

FIG. 4C is a block diagram showing still another functional arrangement of the plant management system 200 according to this example embodiment. In FIG. 4C, in addition to the functional arrangement using the AR technology shown in FIG. 4B, associated information associated with the sensor acquired by the terminal 220 in accordance with an instruction of the operator 250 on work-site is accumulated. Hence, the synergy effect of the sensor information and the associated information enables more reliable sensor information analysis or failure prediction and an instruction of an on-site work for the operator 250 based on the analysis result. Note that the same reference numerals as in FIG. 4A or 4B denote the same constituent elements in FIG. 4C, and a repetitive description thereof will be omitted.

The terminal 220 of the plant management system 200 includes a camera and a sound input/output unit (a microphone and a speaker). In addition, the plant management system 200 includes an abnormality determiner 432 as an option. The abnormality determiner 432 determines an abnormality of a measured value from analysis based on the history of the measured value or sensor information of a sensor and associated information and the normal model or threshold in the storage unit 421.

In the arrangement shown in FIG. 4C, the terminal 220 carried by the operator 250 acquires the terminal position information on work-site using the GPS function or the like, captures the plant by the camera, records the sound near the plant by the microphone, and notifies the sensor information provider 212 of the terminal position information, the plant image, and the plant-associated sound. The sensor information provider 212 selects the sensor, as in FIG. 4A, based on the notified terminal position information, and acquires the sensor information based on the sensor ID. Then, the sensor information provider 212 superimposes the sensor information of the selected sensor on the plant image and presents the sensor information on the terminal 220 carried by the operator 250 on work-site, as in FIG. 4B. In addition, the sensor information provider 212 may present a sound in a normal state or a sound in an abnormal state near the plant, which is accumulated in the sensor information database 211, by the speaker from the terminal 220 carried by the operator 250 on work-site based on the sensor ID.

On the other hand, the sound near the plant, which is recorded by the microphone of the terminal 220, is accumulated in the sensor information database 211 in association with the sensor ID and also sent to the abnormality determiner 432 and used for abnormality determination by the sound.

If the abnormality determiner 432 as an option is included, the list of abnormal sensor IDs estimated as abnormal is generated based on analysis considering the measured value and associated information of the sensor and the normal model or threshold acquired from the storage unit 421 and notified to the sensor information provider 212. Note that, although not shown, it is preferable that the sensor information or associated information is accumulated in the sensor information database 211 in correspondence with the abnormality determination result, and sensor information or associated information useful for the operator 250 on work-site is selected and presented from the terminal 220 carried by the operator 250 on work-site. Furthermore, the normal model or threshold in the storage unit 421 may be generated from analysis of the sensor information or associated information accumulated in the sensor information database 211.

(Hardware Arrangement)

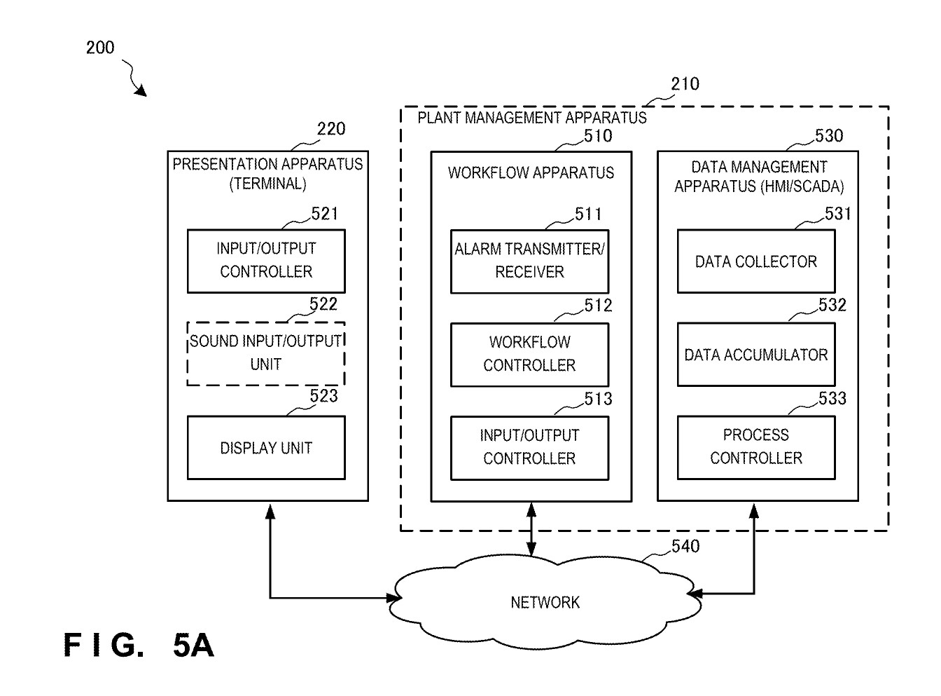

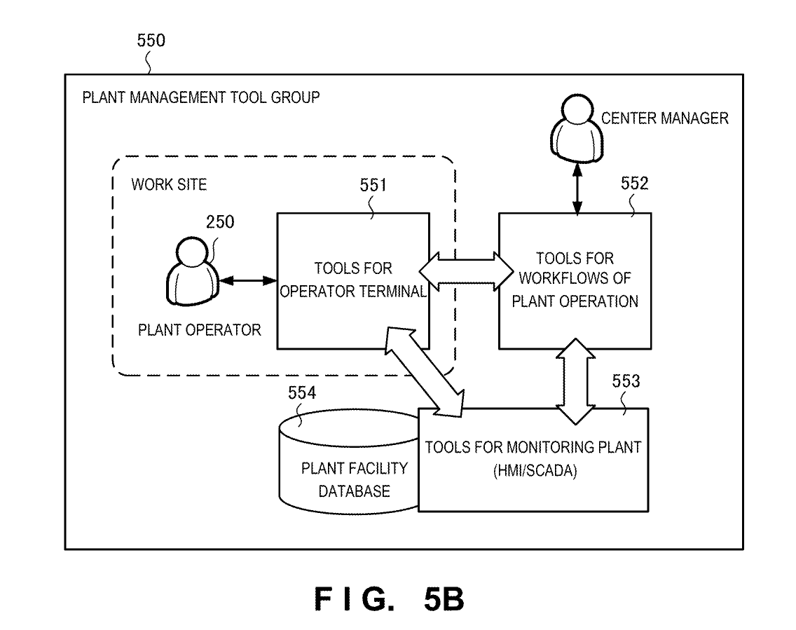

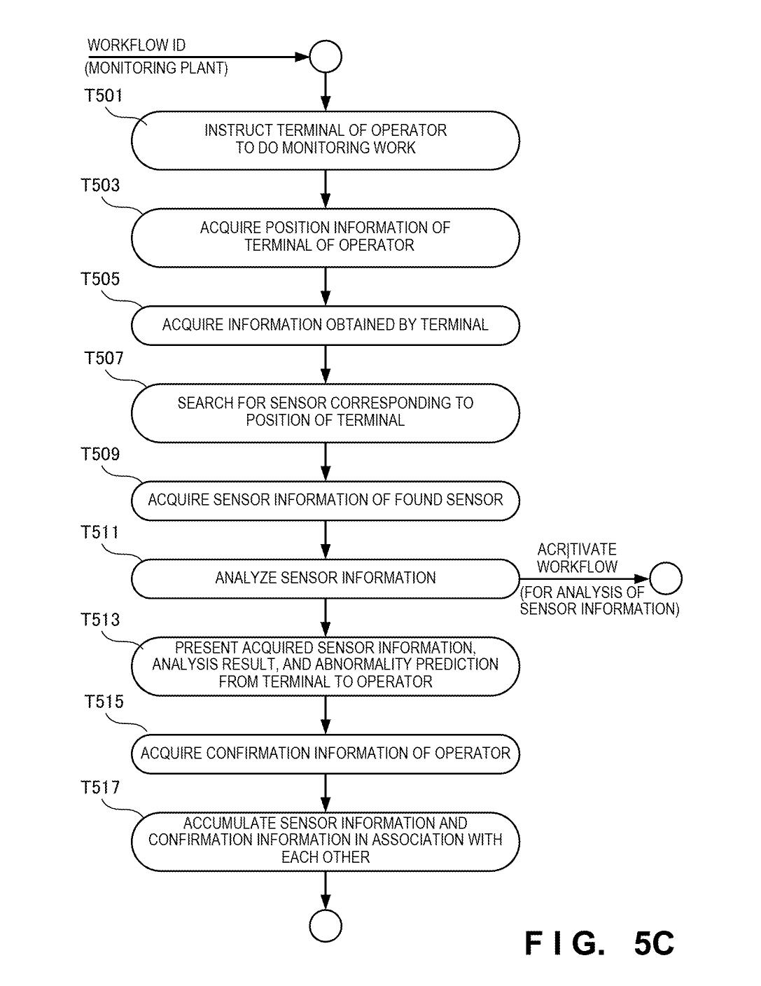

FIG. 5A is a block diagram showing the hardware arrangement of the plant management system 200 according to this example embodiment. Note that in FIG. 5A, the sensor 230 that is a main constituent element of the plant management system 200 is not illustrated to avoid complicatedness. Additionally, the same reference numerals as in FIG. 2A denote the same constituent elements in FIG. 5A. Any apparatus of the plant management system 200 is an apparatus including a processor (CPU: Central Processing Unit) and a memory. The function of each unit of the apparatus is obtained as a result of executing a program stored in the memory by the processor.

Referring to FIG. 5A, the plant management system 200 includes the plant management apparatus 210 and a presentation apparatus that is the terminal 220 carried by the operator 250, which are connected via a network 540. Note that the network 540 is a network formed for the entire plant or across a plurality of plants, and can be configured via the Internet using a VPN (Virtual Private Network) or the like. In addition, whether the network 540 is wired or wireless does not matter.

The plant management apparatus 210 includes a workflow apparatus 510 and a data management apparatus 530. The workflow apparatus 510 includes at least an alarm transmitter/receiver 511, a workflow controller 512, and an input/output controller 513. The alarm transmitter/receiver 511 includes a function of receiving an externally generated alarm and transmitting an alarm to the outside. The workflow controller 512 controls a workflow according to a predetermined notation or standard (for example, ISA (International Society of Automation)-95). The input/output controller 513 controls data input/output according to transmission/reception of an alarm or workflow control. The workflow apparatus 510 may further include a task list unit that displays a task list to the user and performs control concerning a work result input instruction from the user.

In addition, the data management apparatus 530 includes an HMI (Human Machine Interface) function and an SCADA (Supervisory Control And Data Acquisition) function, collects and accumulates data concerning the plant, and analyzes the accumulated data based on the interface to the management of the plant manager, thereby performing process control of the plant. The data management apparatus 530 includes at least a data collector 531, a data accumulator 532, and a process controller 533. The data collector 531 collects data detected by each sensor and data transmitted from another apparatus. The data accumulator 532 accumulates the data collected by the data collector 531 such that a search and analysis can be performed. The process controller 533 analyzes the data accumulated in the data accumulator 532 and performs process control of the plant in correspondence with the analysis result.

In addition, the presentation apparatus that is the terminal 220 carried by the operator 250 includes at least an input/output controller 521, a sound input/output unit 522, and a display unit 523. The input/output controller 521 controls input of a plant image on which a task list or sensor information to be displayed on the display unit 523 is superimposed or input of sound data to be output from the speaker of the sound input/output unit 522 via the network 540. In addition, the input/output controller 521 controls output of current position information of the terminal 220 or image information captured by the camera or output of sound data collected by the microphone of the sound input/output unit 522 via the network 540. The sound input/output unit 522 includes a microphone and a speaker. The display unit 523 includes an operation unit of a touch panel, displays a plant image on which a task list or sensor information is superimposed in association with this example embodiment, and implements operations such as information input associated with a work, a camera operation, and a recording operation. Note that transmission of position information from the terminal 220 includes both the case of an arrangement in which the position information is periodically collected by the plant management apparatus 210 and the case of an arrangement in which the position information is transmitted by the operation of the operator 250 on work-site in an emergency.

Note that in this example embodiment, the alarm transmitter/receiver 511 receives position information, image information, sound information, or the like from the terminal 220 carried by the operator 250 on work-site, determines it as one of alarms of new workflow activation, and transmits the result to the workflow controller 512. The workflow controller 512 implements the characteristic function of this example embodiment by a procedure of activating a workflow to present the sensor information of a sensor on work-site on the terminal 220 carried by the operator 250 on work-site. However, the present invention is not limited to the solving method of adding a change to the arrangement of the alarm transmitter/receiver 511 or the workflow controller 512. The function may be implemented by adding a new functional component or a new workflow to receive position information, image information, sound information, or the like from the terminal 220 carried by the operator 250 on work-site and present the sensor information of a sensor on work-site on the terminal 220 carried by the operator 250 on work-site. Alternatively, the function may be implemented by providing another dedicated apparatus.

(Software Configuration)

FIG. 5B is a block diagram showing the software configuration of the plant management system 200 according to this example embodiment. Note that FIG. 5B shows a minimum arrangement to implement the plant management system 200, and addition of another software tool, fragmentation of an illustrated software tool, overlap of a plurality of software tools, and the like are not shown.

A plant management tool group 550 shown in FIG. 5B includes at least tools for operator terminal 551 that defines and manages processing associated with the terminal 220 that the operator 250 of the plant carries during an on-site work, tools for workflows of plant operation 552 associated with a plant operation by the manager in the center that manages the plant, and tools for monitoring plant 553 that collects data including sensor information and monitors the plant operation. The tools for monitoring plant 553 analyze information in a plant facility database 554 that registers each facility forming the plant and accumulates its driving history, monitors the plant operation, and generates a maintenance operation to find or predict a failure or prevent occurrence of a failure. The tools for operator terminal 551 or the tools for workflows of plant operation 552 generate work-site observation maintenance operations or center management works while referring to output information by the tools for monitoring plant 553.

Note that in this example embodiment, by the cooperation of the tools for workflows of plant operation 552 and the tools for operator terminal 551, sensors are selected based on the position information of the terminal 220 carried by the operator 250 on work-site, and sensor information is presented from the terminal 220 to the operator 250 on work-site. In addition, a result of observation inspection appropriately performed by the operator 250 on work-site while referring to the sensor information presented on the terminal 220 is accumulated in the plant facility database 554 and analyzed by the tools for monitoring plant 553, and the next work-site observation maintenance operations or center management works are generated.

As described above, in this example embodiment, the works of the operator 250 on work-sites do not depend on a desktop analysis result based on only collected sensor information. More improved observation of the operator 250 on work-site or inspection information and the collected sensor information are associated with each other, and the work-site works can more effectively be incorporated in the plant management.

(Workflow)

FIG. 5C is a view showing the workflow of the plant management system 200 according to this example embodiment. Note that FIG. 5C shows an overall workflow using all constituent elements of the plant management system 200, and the workflow is different from a work workflow corresponding to each work to be described below. In addition, the workflow of the plant management system 200 is not limited to that shown in FIG. 5C.

In the workflow of the plant management system 200 shown in FIG. 5C, in task T501, the plant management system 200 instructs the terminal 220 of the operator 250 to do a monitoring work or an inspection work. In task T503, the plant management system 200 acquires the position information of the terminal 220 of the operator 250 on work-site. In task T505, the plant management system 200 acquires information obtained by the terminal 220 in accordance with the operation of the operator 250, for example, an image captured by the camera or a sound acquired by the microphone.

In task T507, the plant management system 200 searches for a sensor corresponding to the position of the terminal 220. In task T509, the plant management system 200 acquires the current or past sensor information of the found sensor. In task T511, the plant management system 200 analyzes the acquired sensor information together with the accumulated sensor information. For example, a workflow for analyzing sensor information may be newly activated.

In task T513, the plant management system 200 presents the acquired sensor information, the analysis result, abnormality prediction, and the like, which are superimposed on, for example, a plant image, from the terminal 220 to the operator 250 on work-site. In task T515, the plant management system 200 waits for a report and completion confirmation of the monitoring work or inspection work instructed in task T501. If the report and completion confirmation of the monitoring work or inspection work are obtained, in task T517, the plant management system 200 accumulates the sensor information and the confirmation information in association with each other.

(Operation Sequence)

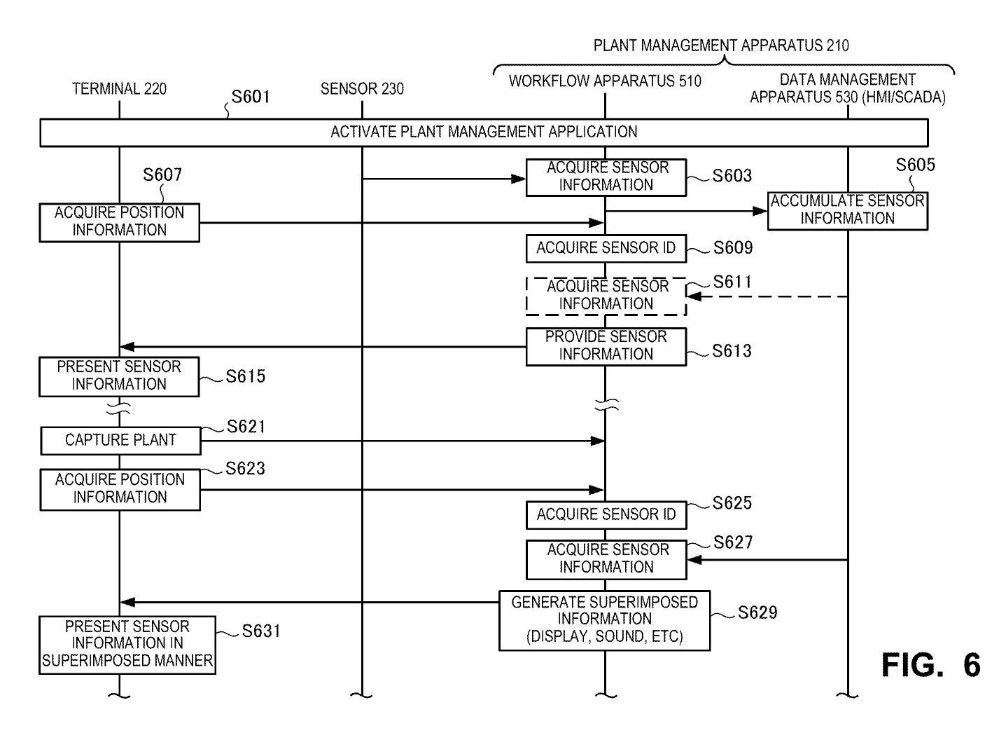

FIG. 6 is a sequence chart showing the operation procedure of the plant management system 200 according to this example embodiment. FIG. 6 shows the operation procedure of presentation of sensor information based on terminal position information corresponding to FIG. 4A and superimposed presentation of sensor information corresponding to FIG. 4B. An operation procedure corresponding to FIG. 4C is not illustrated.

In step S601, the terminal 220, the sensor 230, and the workflow apparatus 510 and the data management apparatus 530 included in the plant management apparatus 210 activate a plant management application for each other. Note that the plant management application need not be one program and may be formed by a plurality of program tool groups. In this case, not all the constituent units need activate the plant management application simultaneously, and each unit activates the plant management application when entering the plant management system 200. For example, the terminal 220 performs login to be connected to the plant management apparatus 210, and the plant management apparatus 210 accepts the login and registers it. In step S603, the workflow apparatus 510 acquires sensor information detected by the sensor 230 and transmits it to the data management apparatus 530. In step S605, the data management apparatus 530 accumulates the sensor information transmitted from the workflow apparatus 510. To accumulate sensor information, the processes of steps S603 and S605 are repeated.

When the terminal 220 carried by the operator 250 on work-site acquires position information and transmits it to the workflow apparatus 510 in step S607, the workflow apparatus 510 acquires the sensor ID of a sensor installed at a sensor position associated with the position information of the terminal 220 in step S609. In step S611, the workflow apparatus 510 acquires the accumulated sensor information or processing information or an analysis result from the data management apparatus 530. Note that if the current sensor information of the sensor 230 is necessary, the sensor information acquired in step S603 may be used.

In step S613, the workflow apparatus 510 provides the sensor information to the terminal 220 carried by the operator 250 on work-site. In step S615, the terminal 220 presents the received sensor information on the display screen in association with a plant image.

An operation procedure of presenting sensor information superimposed on a plant image on the terminal 220 carried by the operator 250 on work-site will be described next.

In step S621, the terminal 220 carried by the operator 250 on work-site captures the plant on work-site by the camera and transmits the captured image to the workflow apparatus 510. When the terminal 220 acquires position information and transmits it to the workflow apparatus 510 in step S623, the workflow apparatus 510 acquires the sensor ID of a sensor installed at a sensor position associated with the position information of the terminal 220 in step S625. In step S627, the workflow apparatus 510 acquires the accumulated sensor information or processing information or an analysis result from the data management apparatus 530.

In step S629, the workflow apparatus 510 generates information in which the current sensor information detected by the sensor 230, or the sensor information or processing information or the analysis result acquired from the data management apparatus 530 is superimposed on the plant image transmitted from the terminal 220 in step S621, and transmits the information to the terminal 220. In step S631, the terminal 220 presents a display screen in which the received sensor information is superimposed on the plant image. Note that in FIG. 6, the sensor information or the like is superimposed on the plant image captured by the terminal 220 using the camera. However, a 3D plant image may be generated based on the data of a plant facility held in the data management apparatus 530, and the sensor information or the like may be superimposed on the 3D plant image.

<<Workflow Apparatus>>

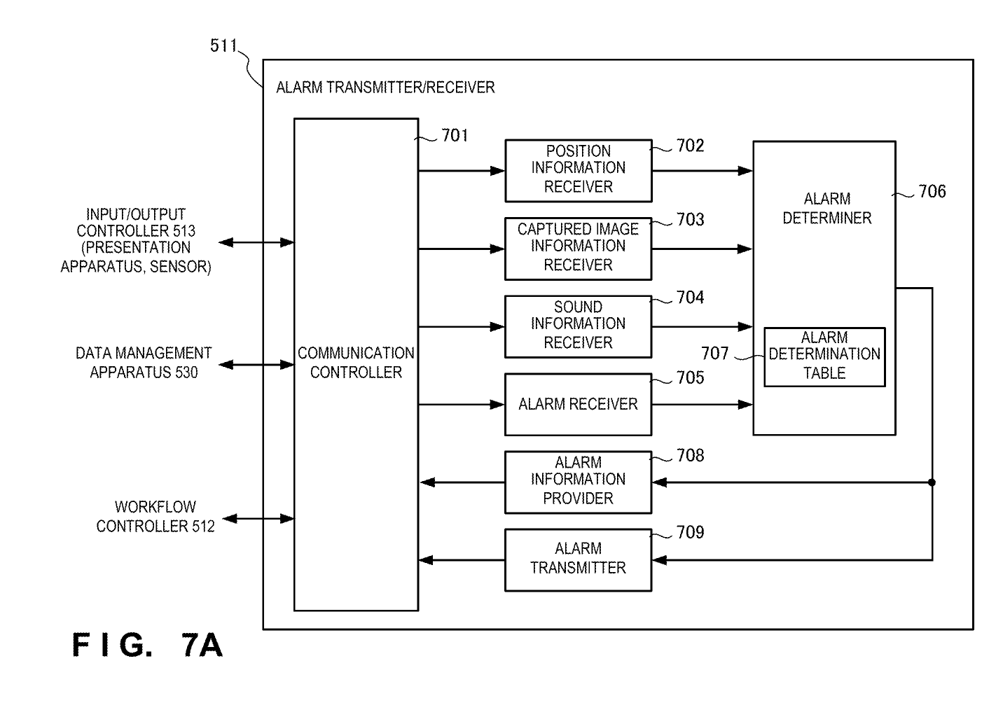

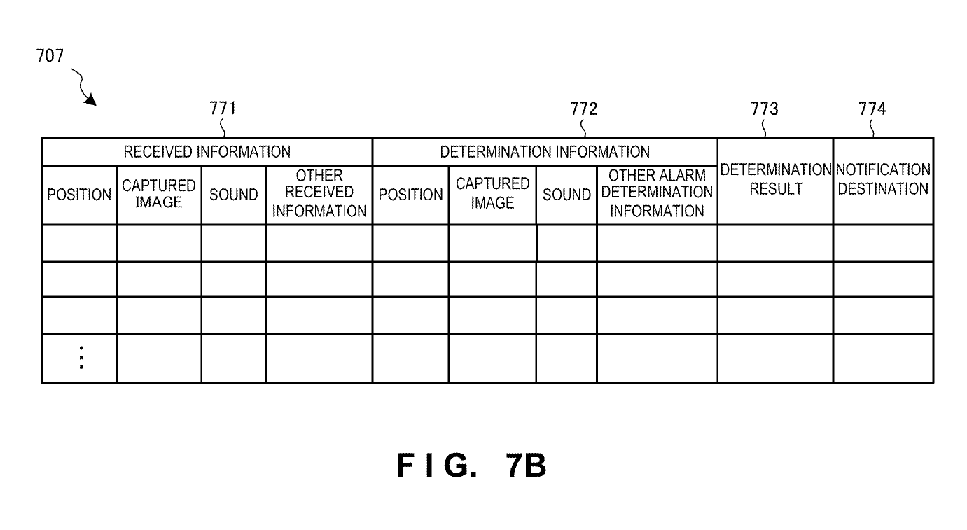

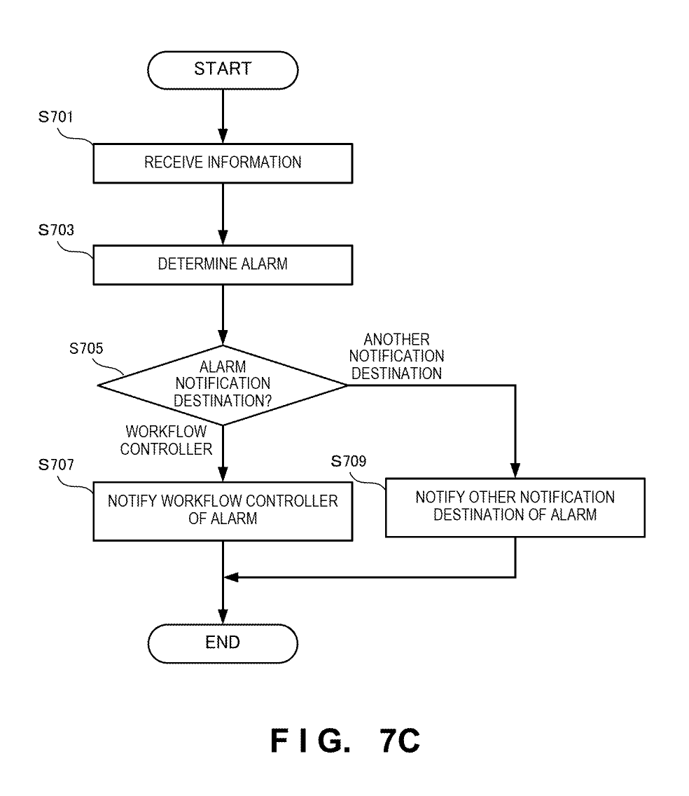

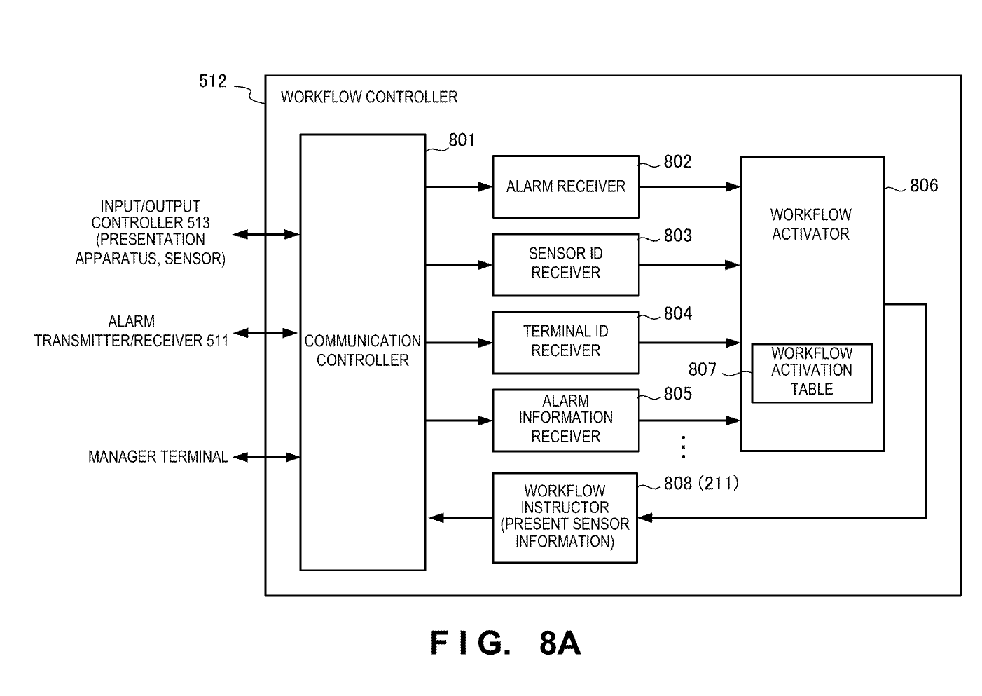

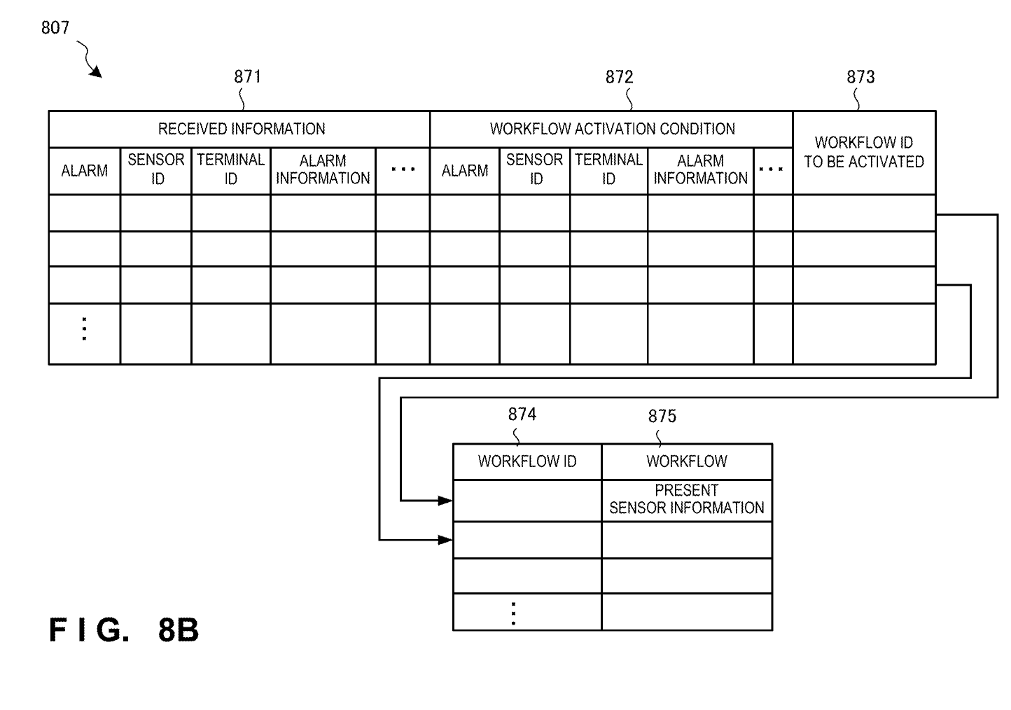

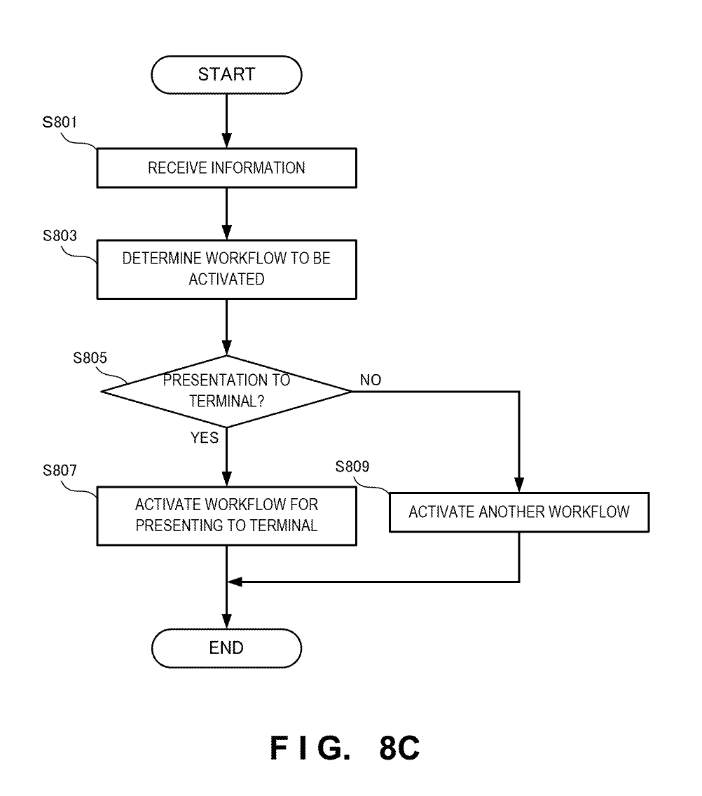

The arrangement and operation of the workflow apparatus 510 according to this example embodiment will be described with reference to FIGS. 7A to 8C. Note that the arrangement and operation for implementing this example embodiment will be explained below concerning the alarm transmitter/receiver 511 and the workflow controller 512 of the workflow apparatus 510.

<<Alarm Transmitter/Receiver>>

FIG. 7A is a block diagram showing the functional arrangement of the alarm transmitter/receiver 511 according to this example embodiment. The alarm transmitter/receiver 511 includes a function of receiving an externally generated alarm and transmitting an alarm to the outside. In this example embodiment, the alarm transmitter/receiver 511 determines the position information of the terminal 220 or image information or sound information from the terminal 220 as reception of an alarm and makes, for the workflow controller 512, an alarm instruction to activate a workflow to present sensor information on the terminal 220.

The alarm transmitter/receiver 511 includes a communication controller 701, a position information receiver 702, capturing captured image information receiver 703, a sound information receiver 704, an alarm receiver 705, and an alarm determiner 706. The alarm determiner 706 includes an alarm determination table 707. The alarm transmitter/receiver 511 further includes an alarm information provider 708 and an alarm transmitter 709.

The communication controller 701 controls communication with the workflow controller 512 and the input/output controller 513 in the same workflow apparatus 510. In addition, the communication controller 701 controls communication with the data management apparatus 530. The position information receiver 702 receives, from the terminal 220, the position information of the terminal 220 via the input/output controller 513 and the communication controller 701. The captured image information receiver 703 receives, from the terminal 220, captured image information captured by the terminal 220 via the input/output controller 513 and the communication controller 701. The sound information receiver 704 receives, from the terminal 220, sound information recorded by the terminal 220 via the input/output controller 513 and the communication controller 701. The alarm receiver 705 receives various alarms from the constituent elements of the plant management system 200 via the communication controller 701.

The alarm determiner 706 determines alarm contents or an alarm destination by the alarm determination table 707 based on the pieces of information received by the receivers 702 to 705. The alarm information provider 708 provides information alarm-determined by the alarm determiner 706 to the alarm destination. In this example embodiment, position information, captured image information, sound information, and the like are provided to the workflow controller 512 as the alarm destination. The alarm transmitter 709 transmits an alarm signal or an alarm type to the alarm destination. In this example embodiment, the alarm transmitter 709 instructs the workflow controller 512 to activate a workflow, and the alarm information provider 708 provides conditions such as position information, captured image information, and sound information to select a workflow to the workflow controller 512.

(Alarm Determination Table)

FIG. 7B is a view showing the arrangement of the alarm determination table 707 according to this example embodiment. The alarm determination table 707 is used to determine, based on the information received by the alarm determiner 706, whether to output an alarm signal and where to output it.

The alarm determination table 707 stores received information 771, determination information 772 for determining whether the received information corresponds to alarm transmission, a determination result 773 representing whether to transmit an alarm, and an alarm notification destination 774 for alarm transmission. The received information 771 includes position information, captured image information, sound information, and other received information. The determination information 772 includes determination conditions to determine whether information is position information from the terminal 220, captured image information from the terminal 220, or sound information from the terminal 220.

(Operation Procedure)

FIG. 7C is a flowchart showing the operation procedure of the alarm transmitter/receiver 511 according to this example embodiment. The processor of the workflow apparatus 510 or the alarm transmitter/receiver 511 executes this flowchart using the memory, and as a result, the functional components shown in FIG. 7A are obtained. In the following explanation, the flowchart is executed by the processor of the workflow apparatus 510.

In step S701, the workflow apparatus 510 receives information. In step S703, the workflow apparatus 510 determines, based on the received information, whether to transmit an alarm. In this example embodiment, it is determined whether the received information is position information, captured image information, or sound information from the terminal 220. If the condition is satisfied, an alarm to communicate activation of a workflow is transmitted to the workflow controller 512.

In step S705, the workflow apparatus 510 determines whether the notification destination of the alarm is the workflow controller 512 or another notification destination. If the notification destination of the alarm is the workflow controller 512, the workflow apparatus 510 notifies the workflow controller 512 of the alarm signal and the received information in step S707. On the other hand, if the notification destination is the other notification destination, the workflow apparatus 510 notifies the other notification destination of the alarm in step S709.

<<Workflow Controller>>

FIG. 8A is a block diagram showing the functional arrangement of the workflow controller 512 according to this example embodiment. The workflow controller 512 controls a workflow according to a predetermined notation or standard, for example, ISA-95. In this example embodiment, the workflow controller 512 receives an alarm to function a workflow from the alarm transmitter/receiver 511 with the position information of the terminal 220 or image information or sound information from the terminal 220 and activates a corresponding workflow.

The workflow controller 512 includes a communication controller 801, an alarm receiver 802, a sensor ID receiver 803, a terminal ID receiver 804, an alarm information receiver 805, and a workflow activator 806. The workflow activator 806 includes a workflow activation table 807. The workflow controller 512 further includes a workflow instructor 808. An instruction by the workflow instructor 808 implements processing of the sensor information provider 212.

The communication controller 801 controls communication with the alarm transmitter/receiver 511 and the input/output controller 513 in the same workflow apparatus 510. In addition, the communication controller 801 controls communication with the manager terminal in the management center. The alarm receiver 802 receives an alarm according to this example embodiment from the alarm transmitter/receiver 511. The sensor ID receiver 803 receives the sensor ID of a sensor as the target of sensor information acquisition. The terminal ID receiver 804 receives the terminal ID of a terminal that presents the sensor information. The alarm information receiver 805 receives alarm information transmitted by the alarm information provider 708 of the alarm transmitter/receiver 511.

The workflow activator 806 selects a workflow to be activated and parameters to be used by the workflow activation table 807 based on the pieces of information received by the receivers 802 to 805. The workflow instructor 808 instructs a corresponding component in the plant management system 200 to activate the workflow selected by the workflow activator 806 using the parameters. In this example embodiment, a workflow corresponding to the alarm information is selected from workflows for presenting sensor information on the terminal of the operator based on the pieces of information received by the receivers 802 to 805 and activated while adding the sensor ID, the terminal ID, and the alarm information as parameters.

(Workflow Activation Table)

FIG. 8B is a view showing the arrangement of the workflow activation table 807 according to this example embodiment. The workflow activation table 807 is used to select a workflow to be activated from an alarm received from the alarm transmitter/receiver 511 and each received information.

The workflow activation table 807 stores a workflow ID 873 to be activated, which is selected based on received information 871 and a workflow activation condition 872. In addition, the workflow ID 873 to be activated is instructed as a pointer, and a workflow 875 is selected from the table that stores a workflow ID 874 and the workflow 875 are stored in in association. The received information 871 includes the received alarm, sensor ID, terminal ID, and alarm information. In addition, the workflow activation condition 872 includes the alarm, sensor ID, terminal ID, and alarm information as conditions to select a workflow to be activated from the received information 871.

(Operation Procedure)

FIG. 8C is a flowchart showing the operation procedure of the workflow controller 512 according to this example embodiment. The processor of the workflow apparatus 510 or the workflow controller 512 executes this flowchart using the memory, and as a result, the functional components shown in FIG. 8A are obtained. In the following explanation, the flowchart is executed by the processor of the workflow apparatus 510.

In step S801, the workflow apparatus 510 receives information. In step S803, the workflow apparatus 510 determines a workflow to be activated based on the received information. In this example embodiment, a workflow group for presenting sensor information on the terminal is selected based on a received alarm. Then, workflows corresponding to the processing contents or presentation format of the sensor are selected based on the sensor ID and the terminal ID. Furthermore, the workflows are narrowed down to a workflow corresponding to the presentation method based on alarm information including position information, captured image information, or sound information.

In step S805, the workflow apparatus 510 determines whether the selected workflow is to present sensor information the terminal. If the selected workflow is to present sensor information to the terminal, the workflow apparatus 510 activates the workflow for presenting the sensor information on the terminal on work-site in step S807. On the other hand, if the selected workflow is another workflow, the workflow apparatus 510 activates the other workflow in step S809.

<<Data Accumulation Analysis Apparatus>>

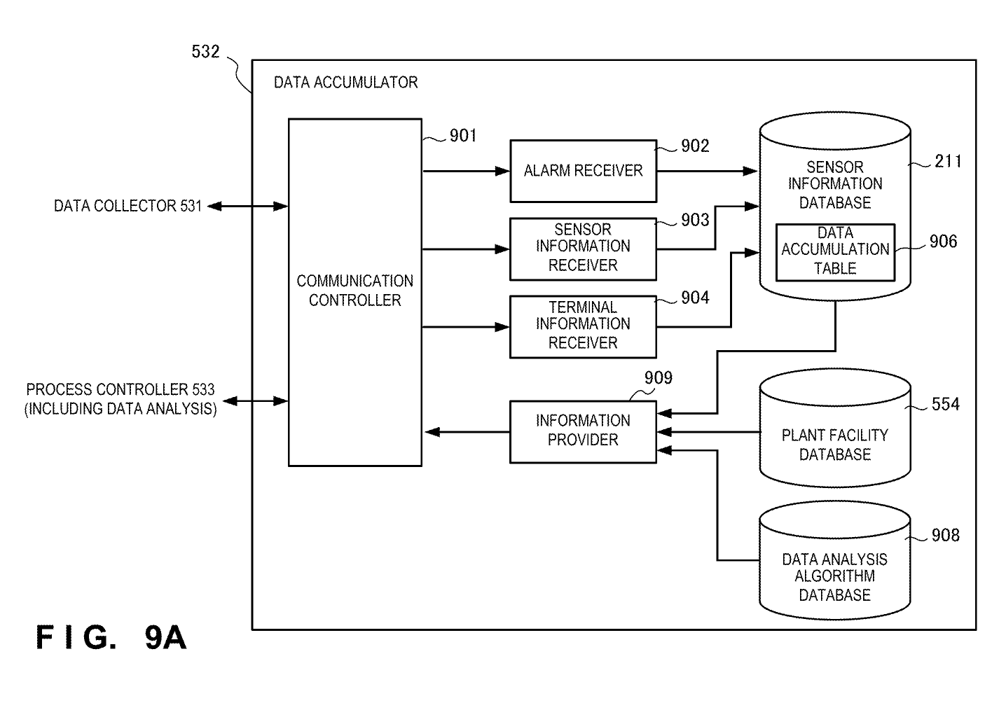

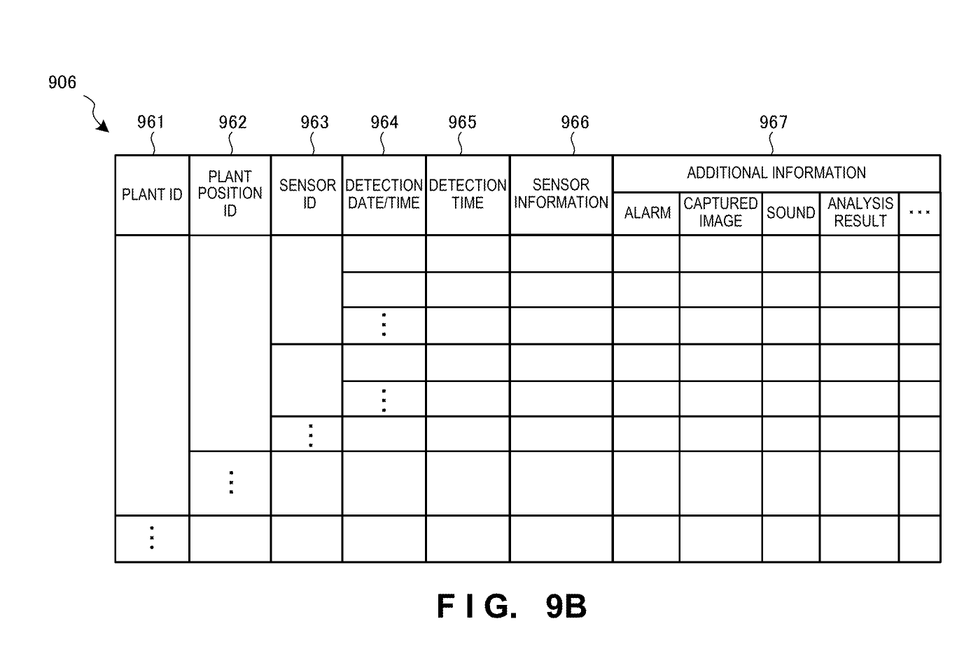

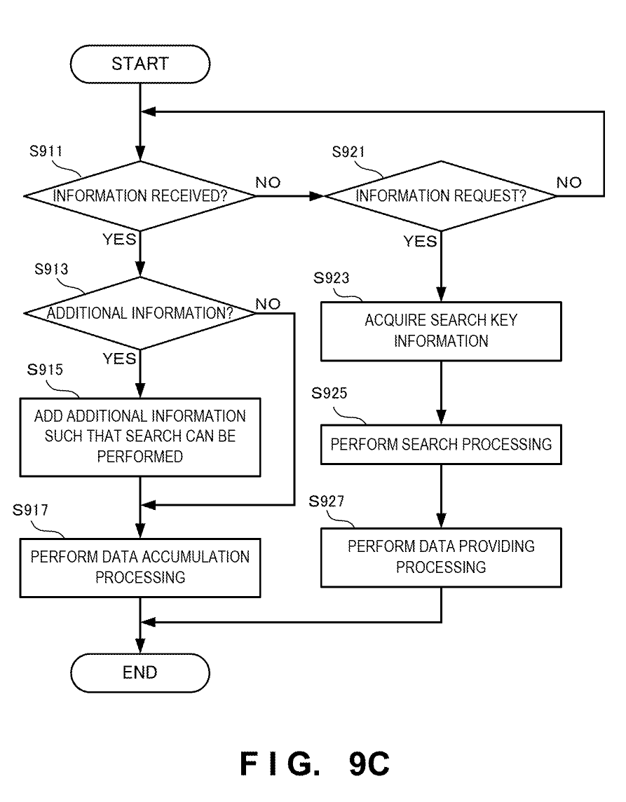

The arrangement and operation of the data management apparatus 530 according to this example embodiment will be described with reference to FIGS. 9A to 9C.

<<Data Accumulator>>

FIG. 9A is a block diagram showing the functional arrangement of the data accumulator 532 according to this example embodiment. The data accumulator 532 is located in the data management apparatus 530 and accumulates data collected by the data collector 531. In this example embodiment, the operator 250 at a plant position at which a sensor is installed adds associated information acquired by instructing the terminal 220 to sensor information detected by each sensor while referring to the sensor information and accumulates the sensor information in the sensor information database 211.

The data accumulator 532 includes a communication controller 901, an alarm receiver 902, a sensor information receiver 903, a terminal information receiver 904, and the sensor information database 211. The sensor information database 211 includes a data accumulation table 906. The data accumulator 532 further includes the plant facility database 554, a data analysis algorithm database 908, and an information provider 909.

The communication controller 901 controls communication with the data collector 531 and the process controller 533 in the same data management apparatus 530. The alarm receiver 902 receives an alarm generated by the plant management system 200. The sensor information receiver 903 receives sensor information detected by each sensor in association with a sensor ID. The terminal information receiver 904 receives terminal information acquired and transmitted by each terminal.

The sensor information database 211 accumulates sensor information detected by each sensor in association with an alarm or portable information such that a search and analysis can be performed. The plant facility database 554 stores facility information forming the plant of the management target. The data analysis algorithm database 908 stores a data analysis algorithm that performs abnormality diagnosis or prediction or a maintenance operation while combining the sensor information accumulated in the sensor information database 211 with associated information. The information provider 909 acquires information necessary for presentation of sensor information or associated information to the terminal, 3D plant image generation from plant facility information, or data analysis by the process controller 533 from the database 211, 907, or 908 and provides the information.

(Data Accumulation Table)

FIG. 9B is a view showing the arrangement of the data accumulation table 906 according to this example embodiment. The data accumulation table 906 is used to store sensor information detected by each sensor in association with associated information such that a search and analysis can be performed.

The data accumulation table 906 stores plant position IDs 962 of a plurality of partial plants in correspondence with each plant ID 961. In addition, a plurality of sensor IDs 963 installed in correspondence with each plant position ID 962 are stored. Furthermore, a plurality of detection dates/times 964 are stored in correspondence with each sensor ID 963.

A detection time 965, detected sensor information 966, and additional information 967 including associated information are stored in association with each detection date/time 964. The additional information 967 includes alarm information when the sensor information 966 is acquired, a captured image or sound acquired by the terminal on work-site as the associated information, or an analysis result based on the currently detected sensor information 966 or accumulated past sensor information.

(Operation Procedure)

FIG. 9C is a flowchart showing the operation procedure of the data accumulator 532 according to this example embodiment. The processor of the data management apparatus 530 or the data accumulator 532 executes this flowchart using the memory, and as a result, the functional components shown in FIG. 9A are obtained. In the following explanation, the flowchart is executed by the processor of the data management apparatus 530.

In step S911, the data management apparatus 530 determines whether information is received. If information is received, in step S913, the data management apparatus 530 determines whether additional information such as associated information associated with sensor information exists. If additional information exists, in step S915, the data management apparatus 530 adds the additional information such as associated information to the sensor information such that a search and analysis can be performed. In step S917, the data management apparatus 530 accumulates the sensor information or the sensor information to which the additional information is added in the sensor information database 211 using a format as shown in FIG. 9B.

On the other hand, if information is not received, in step S921, the data management apparatus 530 determines whether an information request from another apparatus or another functional component in the plant management system 200 is received. If an information request is received, in step S923, the data management apparatus 530 acquires, from the information request source, a search key used to search the sensor information database 211 for the sensor information or the sensor information to which the additional information is added. In step S925, the data management apparatus 530 searches the sensor information database 211 for the data using the acquired search key. In step S927, the data management apparatus 530 provides the found data to the information request source.

In this example embodiment, the sensor information database 211 is searched for the sensor information or the sensor information to which the additional information is added using, as the search key, the sensor ID of a sensor corresponding to the current position information of the terminal 220 carried by the operator 250 on work-site or a detection condition (for example, a detection date/time) of the sensor information of the sensor to be presented on the terminal 220. The found sensor information or sensor information to which the additional information is added is provided to the terminal 220 carried by the operator 250 on work-site. In this case, if the workflow is a workflow for superimposing the sensor information on a plant image, superimposition processing is performed. Alternatively, if the workflow includes processing or analysis of sensor information, abnormality occurrence prediction, or the like, the process controller 533 executes processing or analysis, or abnormality occurrence prediction and provides the information to the terminal 220 carried by the operator 250 on work-site.

<<Workflow>>

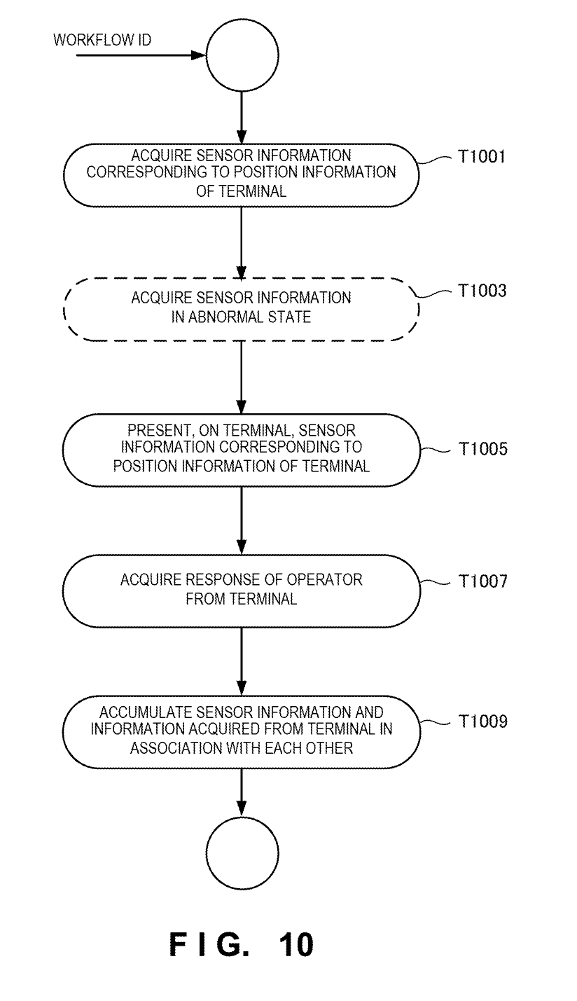

FIG. 10 is a view showing the workflow of a work according to this example embodiment. Note that the workflow shown in FIG. 10 is a new workflow that describes a processing portion for presenting sensor information corresponding to the terminal on work-site in this example embodiment. The workflow to be described below indicates a work procedure executed by the workflow apparatus 510 using the constituent apparatuses or functional components of the plant management system. Note that FIG. 10 shows only minimum basic tasks of this example embodiment, and various tasks may be added.

In task T1001, the workflow apparatus 510 acquires the sensor information of a sensor corresponding to position information acquired from the terminal on work-site. In task T1003, if necessary, the workflow apparatus 510 acquires sensor information of the sensor in an abnormal state (or in a normal state). In step T1005, the workflow apparatus 510 presents the sensor information of the sensor corresponding to the position information of the terminal on work-site from the terminal to the operator on work-site.

In task T1007, the workflow apparatus 510 waits for the response of the operator from the terminal on work-site and acquires a work result of observation or inspection referring to the presentation of the sensor information. In task T1009, the workflow apparatus 510 accumulates the sensor information in association with obtained information such as associated information from the terminal such that a search based on the sensor ID can be performed.

According to this example embodiment, the sensor information of the sensor on the work site is presented to the operator, and simultaneously, associated information associated with the sensor from the operator is collected and accumulated. This makes it possible to more efficiently support the on-site work of the operator who checks or maintains a structure such as a plant.

That is, since the operator can confirm the sensor information on work-site, and analysis can be performed in consideration of the information of observation or experience of the operator, a point of abnormality can easily be specified. In addition, since the operator can specify a cause of abnormality by comparing and examining the situation on work-site, a suspicious point of abnormality can efficiently be monitored by the operator.

### Third Example Embodiment

A plant management system according to the third example embodiment of the present invention will be described next. The plant management system according to this example embodiment is different from the above-described second example embodiment in that sensor information is projected to an operator on a work site. In this example embodiment, sensor information associated with the site is projected from a projection apparatus, and the associated information of the sensor is acquired from the operator. Here, as the projection apparatus, a projection device such as a laser or a projector that performs projection is used. In addition, the sensor information may be projected from a wristband or goggles other than a device installed at a fixed position on a ceiling or the like. Note that the projection apparatus will also be referred to as a projector. The rest of the components and operations is the same as in the second example embodiment. Hence, the same reference numerals denote the same components and operations, and a detailed description thereof will be omitted.

<<Plant Management System>>

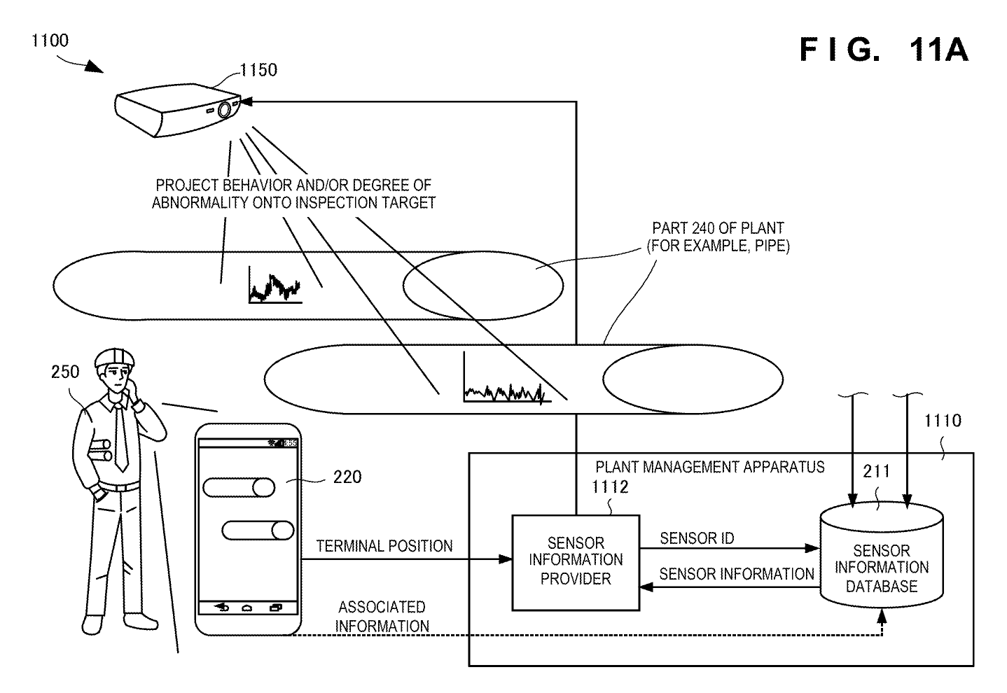

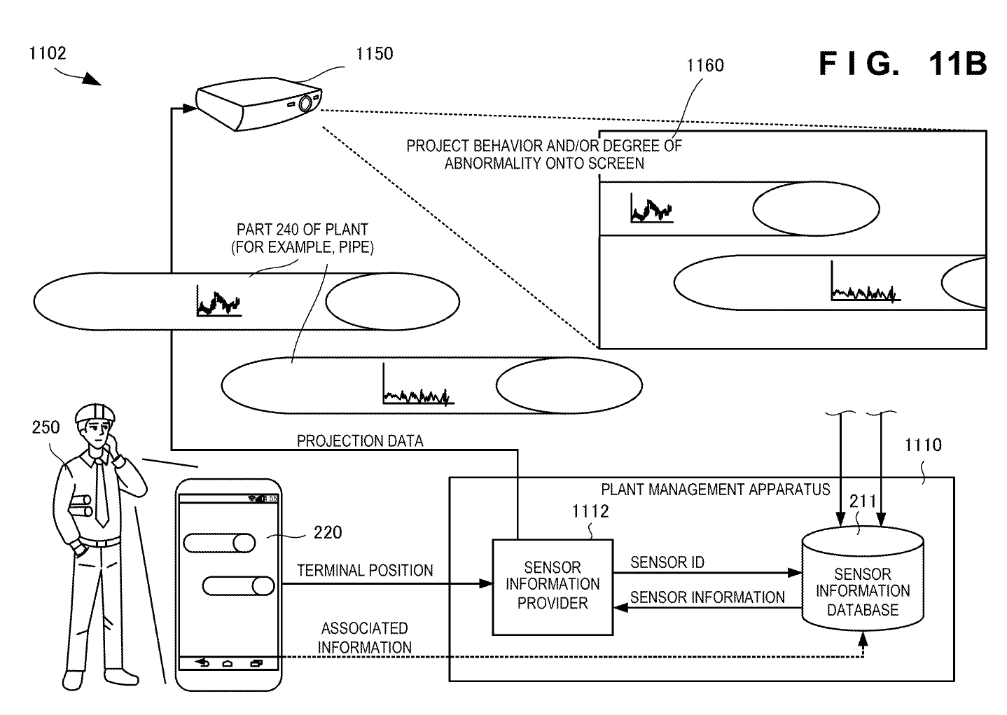

The arrangement and operation of a plant management system 1100 according to this example embodiment will be described with reference to FIGS. 11A to 14.

(Operation Outline)

FIG. 11A is a view showing an operation outline of the plant management system 1100 according to this example embodiment. Note that the same reference numerals as in FIG. 2A denote the same constituent elements in FIG. 11A, and a repetitive description thereof will be omitted.

Referring to FIG. 11A, the plant management apparatus 1110 includes a sensor information provider 1112. When current position information is acquired from a terminal 220 carried by an operator 250 on work-site, the sensor information provider 1112 selects a corresponding sensor and projects the sensor information of the sensor from a projector serving as a projection apparatus 1150 to a part 240 of a plant on which the sensor is set.

FIG. 11B is a view showing another operation outline of the plant management system 1100 according to this example embodiment. Note that the same reference numerals as in FIG. 2A or 11A denote the same constituent elements in FIG. 11B, and a repetitive description thereof will be omitted.

Referring to FIG. 11B, the projector serving as the projection apparatus 1150 projects the sensor information of the sensor corresponding to the current position information of the terminal 220 on work-site to a position of a screen 1160.

(Functional Arrangement)

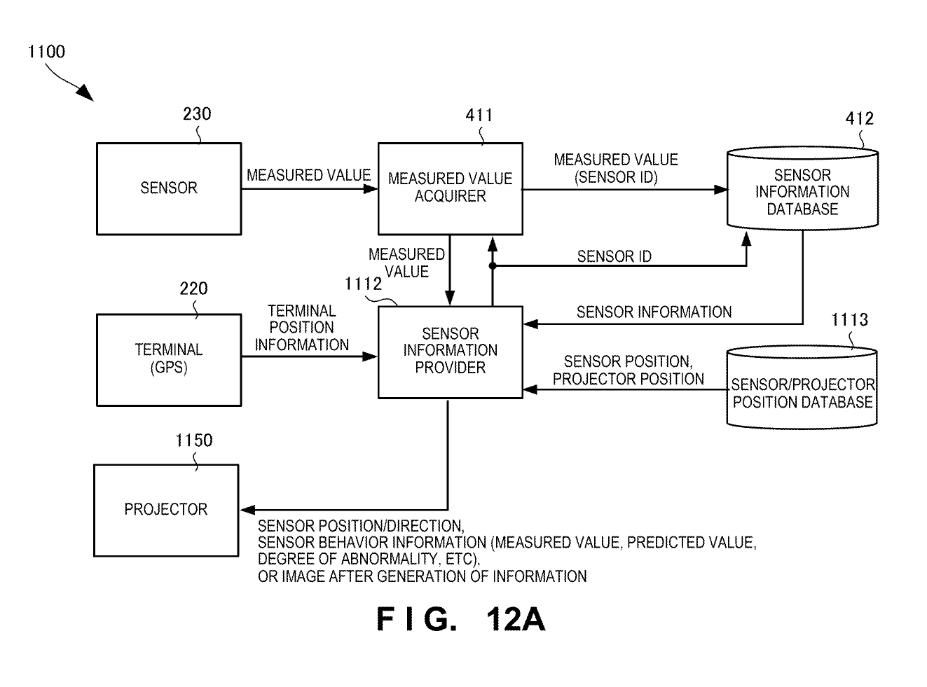

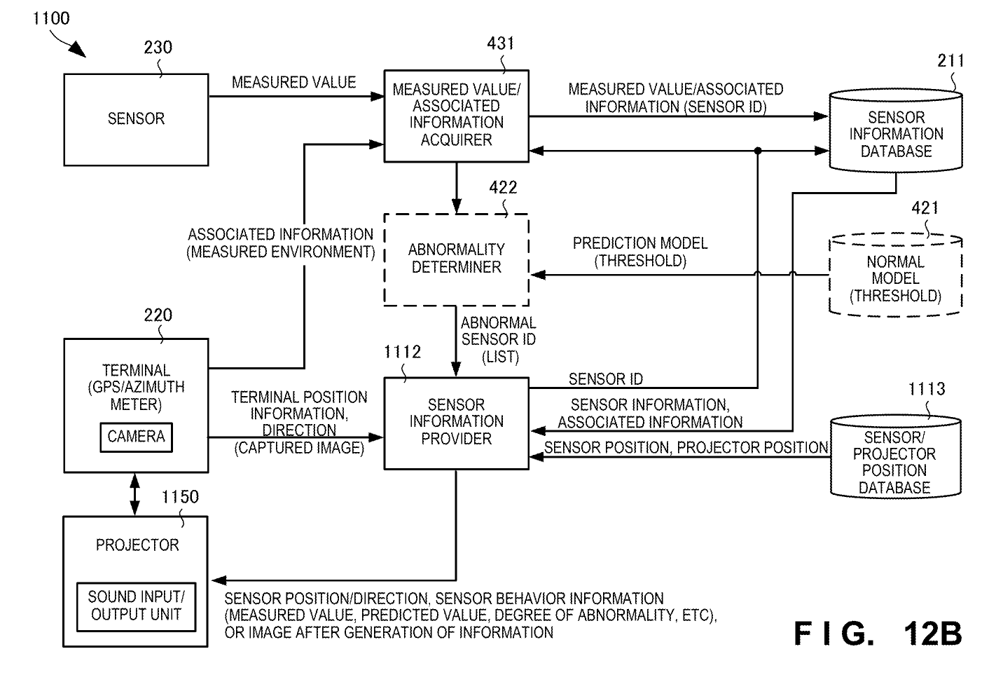

FIG. 12A is a block diagram showing a functional arrangement of the plant management system 1100 according to this example embodiment. Note that the same reference numerals as in FIGS. 4A to 4C denote the same constituent elements in FIG. 12A, and a repetitive description thereof will be omitted.

The sensor information provider 1112 of the plant management system 1100 acquires a sensor position and a projector position stored in a sensor/projector position database 1113. Then, the sensor information provider 1112 obtains the sensor ID of a corresponding sensor from the current position information of the terminal 220 and acquires sensor information from a measured value acquirer 411 or a sensor information database 211. In addition, the sensor information provider 1112 obtains the projector ID of a corresponding projector from the current position information of the terminal 220 and causes the projector 1150 to project the sensor information.

FIG. 12B is a block diagram showing another functional arrangement of the plant management system 1100 according to this example embodiment. Note that the same reference numerals as in FIGS. 4A to 4C or FIG. 12A denote the same constituent elements in FIG. 12B, and a repetitive description thereof will be omitted.

The sensor information provider 1112 of the plant management system 1100 acquires a sensor position and a projector position stored in the sensor/projector position database 1113. Then, the sensor information provider 1112 obtains the sensor ID of a corresponding sensor from the current position information of the terminal 220 and acquires sensor information from the measured value acquirer 411 or the sensor information database 211. In addition, the sensor information provider 1112 obtains a plant image on work-site captured by the camera of the terminal 220 and superimposes the sensor information on the plant image. If necessary, associated information accumulated in the sensor information database 211 is also superimposed on the plant image. The sensor information provider 1112 obtains the projector ID of a corresponding projector from the current position information of the terminal 220 and causes the projector 1150 to project the plant image on which the sensor information or associated information (for example, an analysis result or a sound) is superimposed.

Note that FIG. 12B also shows a case in which projection processing of the sensor information on work-site according to this example embodiment is started using near field communication (for example, beacon) between the terminal 220 on work-site and the projector 1150 as a trigger. In this case, the terminal 220 may be not a high function device such as a smartphone or a tablet but a device having only the near field communication function. As the plant image on which the sensor information is superimposed, a 3D plant image which is generated based on a plant facility and through which the internal structure is visible is used.

(Hardware Arrangement)

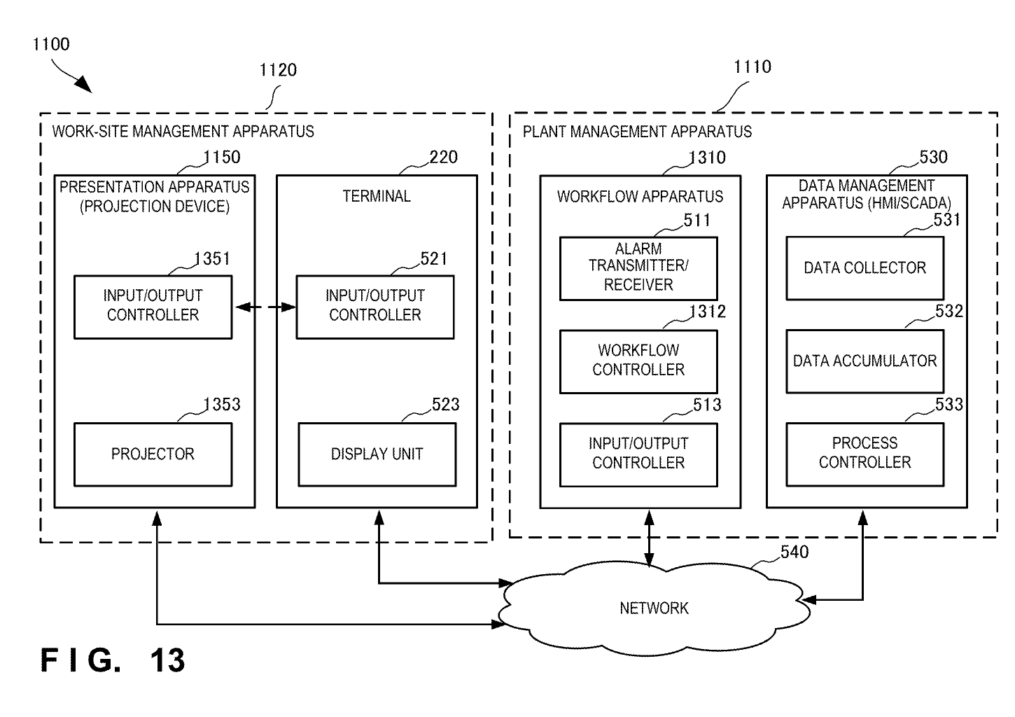

FIG. 13 is a block diagram showing the hardware arrangement of the plant management system 1100 according to this example embodiment. Note that the same reference numerals as in FIG. 5A denote the same functional components in FIG. 13, and a repetitive description thereof will be omitted.

The plant management system 1100 includes a plant management apparatus 1110 and a work-site management apparatus 1120, which are connected via a network 540. A workflow apparatus 1310 that constitutes the plant management apparatus 1110 activates a workflow for causing a projection device such as a projector that is the projection apparatus 1150 serving as a presentation apparatus according to this example embodiment to project sensor information.

On the other hand, the projection apparatus 1150 serving as a presentation apparatus that constitutes the work-site management apparatus 1120 includes an input/output controller 1351 that controls input/output to/from another apparatus, and a projector 1353 that projects sensor information or an image in which sensor information is superimposed on a plant image. The input/output controller 1351 controls input of the sensor information or the image in which the sensor information is superimposed on the plant image. Additionally, if near field communication is performed between the terminal 220 and the projector 1150, as shown in FIG. 12B, the input/output controller 1351 performs near field communication.

(Operation Sequence)

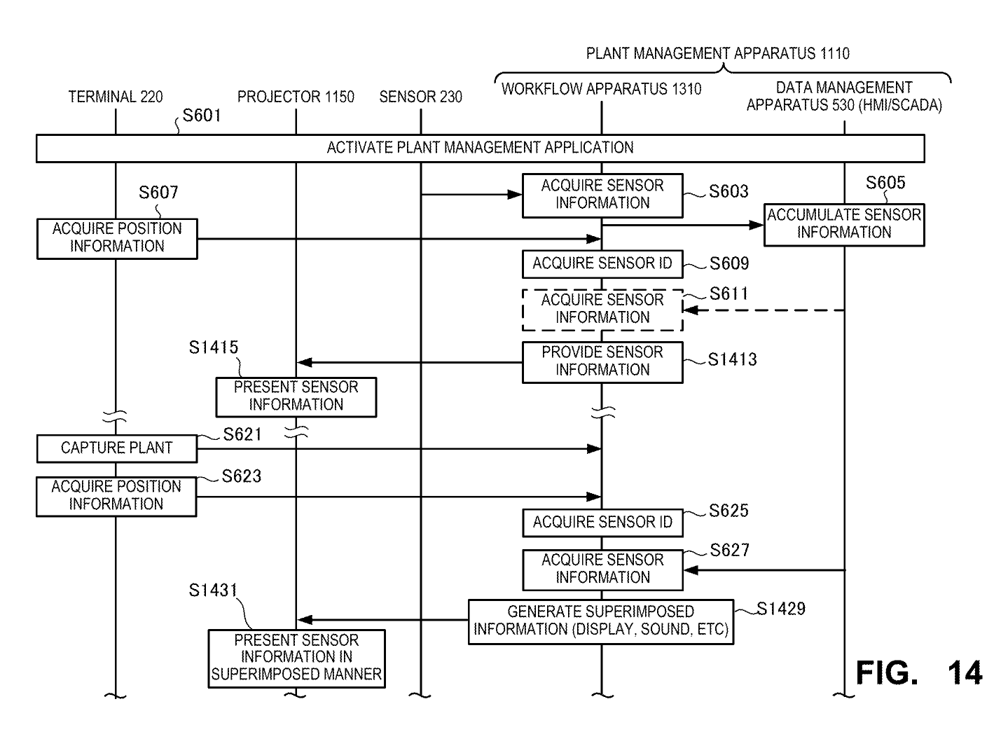

FIG. 14 is a sequence chart showing the operation procedure of the plant management system 1100 according to this example embodiment. Note that the same step numbers as in FIG. 6 denote the same steps in FIG. 14, and a repetitive description thereof will be omitted.

In step S1413, the workflow apparatus 1310 provides the sensor information of a sensor corresponding to current position information acquired from the terminal 220 on work-site to the projector 1150 corresponding to the current position information. In step S1415, the projector 1150 projects the sensor information or a plant image on which the sensor information is superimposed, thereby presenting it to the operator 250 on work-site.

In step S1429, the workflow apparatus 1310 superimposes the sensor information of the sensor corresponding to the current position information acquired from the terminal 220 on work-site on the plant image on work-site captured by the terminal 220 and provides the image to the projector 1150 corresponding to the current position information. In step S1431, the projector 1150 projects the sensor information or the plant image on which the sensor information is superimposed, thereby presenting it to the operator 250 on work-site.

<<Workflow>>

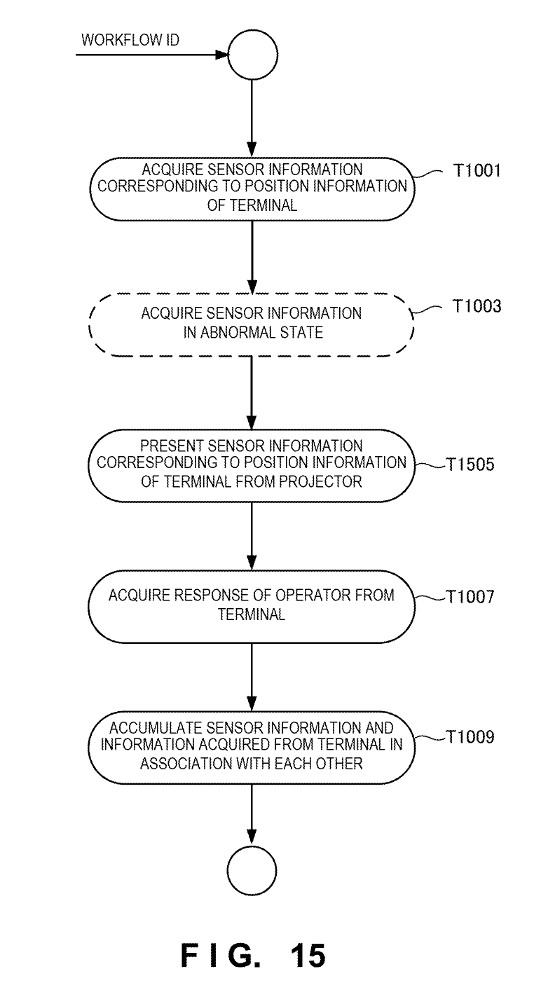

FIG. 15 is a view showing the workflow of a work according to this example embodiment. Note that the same step numbers as in FIG. 10 denote the same steps in FIG. 15, and a repetitive description thereof will be omitted.

In task T1505, the workflow apparatus 1310 presents the sensor information of the sensor corresponding to the position information from the terminal 220 on work-site from the projector 1150 corresponding to the position information to the operator 250 on work-site.

According to this example embodiment, the projection apparatus having a projection function is arranged on work-site. It is therefore possible to efficiently support the on-site work of the operator who checks or maintains a structure such as a plant without carrying a predetermined device. That is, the terminal need not be carried.

### Fourth Example Embodiment

A plant management system according to the fourth example embodiment of the present invention will be described next. The plant management system according to this example embodiment is different from the above-described second and third example embodiments in that an operator is supported by a different sensor information presentation method or a different method of acquiring associated information of a sensor from an operator. The rest of the components and operations is the same as in the second example embodiment. Hence, the same reference numerals denote the same components and operations, and a detailed description thereof will be omitted.

<<First Presentation Example and Workflow>>

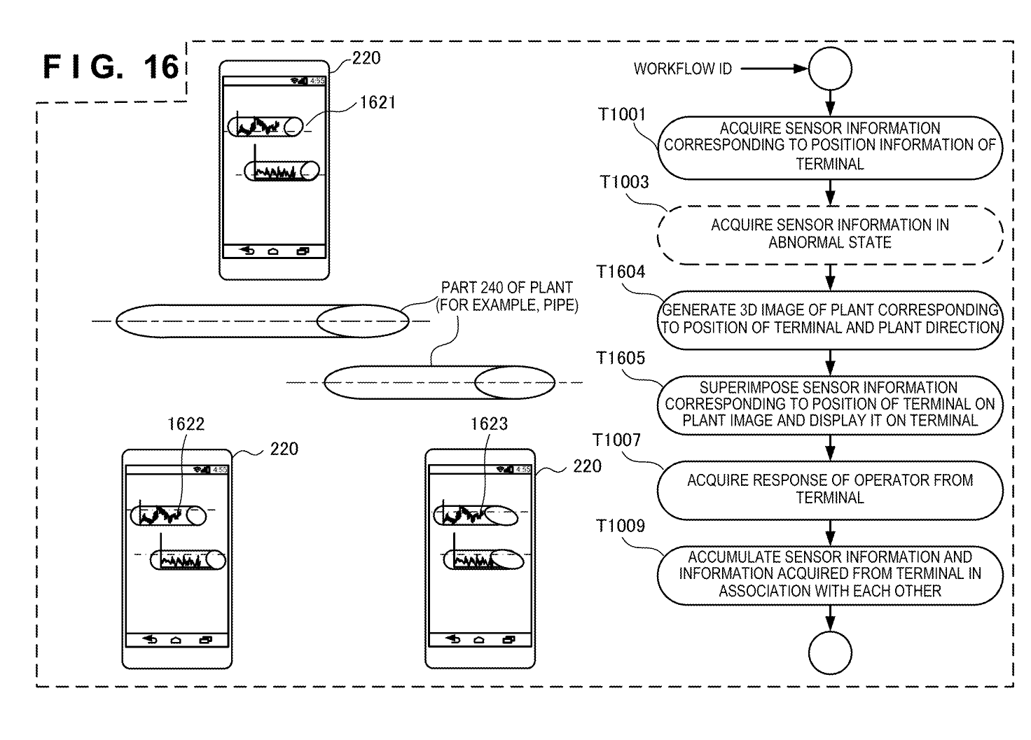

FIG. 16 is a view showing the first presentation example on work-site in the plant management system according to this example embodiment and a corresponding workflow.

In the first presentation example shown in FIG. 16, how to hold a terminal 220 at the time of superimposition of sensor information or the line of sight of an operator 250 seeing the plant is also associated. A transparent image completely straight to the screen may be displayed. However, the operator may hold the terminal to confirm the superimposed image while viewing the actual plant. In this case, an image not in a straight see-through direction but with a slight upward or downward angle may be presented. In a state in which the terminal 220 is viewed in a normal orientation, a facility on front is presented as if it is viewed from the front side. Note that this is impossible in the camera of a normal tablet but can be implemented using a device in which the direction of the camera is corrected upward or downward.

The left view of FIG. 16 shows, with respect to a part 240 of the plant on work-site, a plant display 1621 in a case in which the operator 250 is observing the plant downward from the upper side, a plant display 1622 in a case in which the operator 250 is observing the plant from the lower side to the upper right side, and a plant display 1623 in a case in which the operator 250 is observing the plant from the lower side to the upper left side.

The right view of FIG. 16 shows a workflow for implementing presentation of the plant image and the sensor information shown in the left view of FIG. 16 to the operator 250 on work-site. Note that the same task numbers as in FIG. 10 denote the same tasks in the right view of FIG. 16, and a repetitive description thereof will be omitted.

In task T1604, a workflow apparatus 510 generates a 3D image of the plant corresponding to the position of the terminal 220 and the plant direction. Note that a plant image captured by the camera of the terminal 220 may be deformed. In task T1605, the workflow apparatus 510 superimposes sensor information corresponding to the position information of the terminal 220 on the generated plant image in the direction, displays the image on the terminal 220, and presents it to the operator 250 on work-site.

According to the first presentation example, the operator can easily associate presentation of a model image with observation depending on the position of the terminal 220.

<<Second Presentation Example and Workflow>>

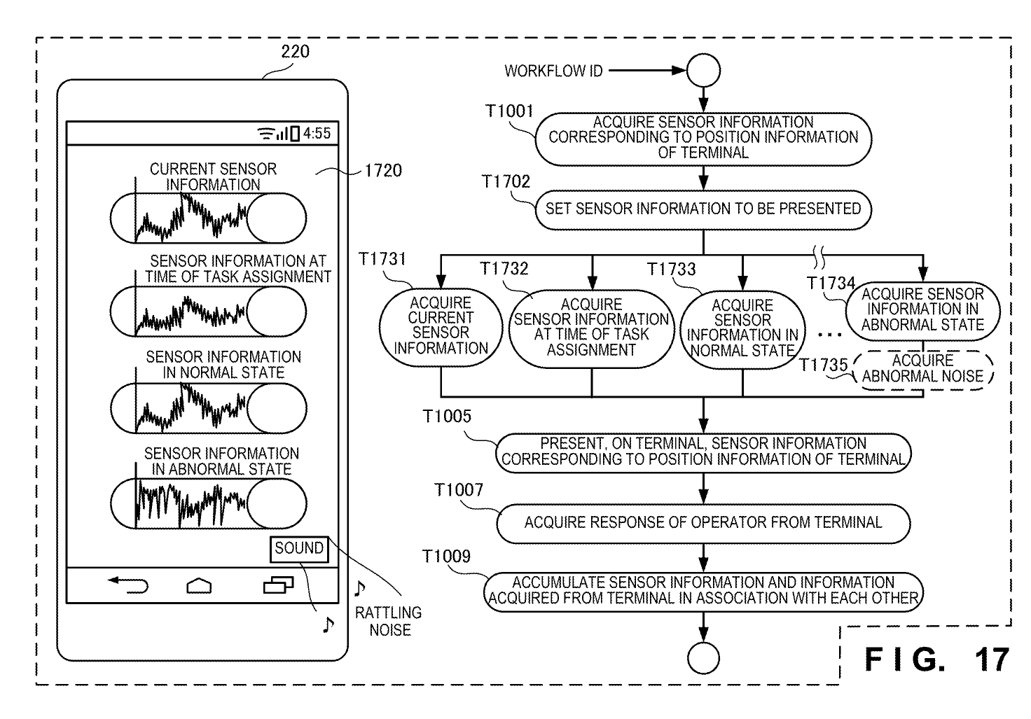

FIG. 17 is a view showing the second presentation example on work-site in the plant management system according to this example embodiment and a corresponding workflow.

In the second presentation example shown in FIG. 17, the time range of sensor information (for example, a graph) may be decided in association with a task. However, for example, a graph in which a time at which a task is assigned to the operator is the start time, or time information (for example, a workflow activation time) associated with a task may be employed instead.

The left view of FIG. 17 shows a display screen 1720 that not only presents the current sensor information of a sensor on work-site but also makes a presentation useful for the operator 250, such as a waveform at the time of task assignment, a previous history waveform, or a waveform or sound in a normal state/abnormal state in different time ranges. Note that various kinds of different presentations in different time ranges are presented all together in the left view of FIG. 17. However, making only a presentation useful for the operator 250 suffices.

The right view of FIG. 17 shows a workflow for implementing presentation of the plant image and the sensor information shown in the left view of FIG. 17 to the operator 250 on work-site. Note that the same task numbers as in FIG. 10 denote the same tasks in the right view of FIG. 17, and a repetitive description thereof will be omitted.

In task T1702, the workflow apparatus 510 sets sensor information to be presented to a time range useful for the operator 250 in correspondence with an on-site work. If the current sensor information is preferable, in task T1731, the workflow apparatus 510 acquires the current sensor information of the sensor on work-site. If sensor information at the time of task assignment to the operator 250 is preferable, in task T1732, the workflow apparatus 510 acquires the sensor information of the sensor on work-site at the time of task assignment. If sensor information in a normal operation of the plant is preferable, in task T1733, the workflow apparatus 510 acquires the sensor information of the sensor on work-site in the normal operation. Alternatively, if sensor information in an abnormal state of the plant or sensor is preferable, in task T1734, the workflow apparatus 510 acquires the sensor information of the sensor on work-site in the abnormal state of the plant or sensor. If necessary, an abnormal noise is acquired in task T1735.

According to the second presentation example, sensor information useful for the operator on work-site can be presented by adjusting the time range of display.

<<Third Presentation Example and Workflow>>

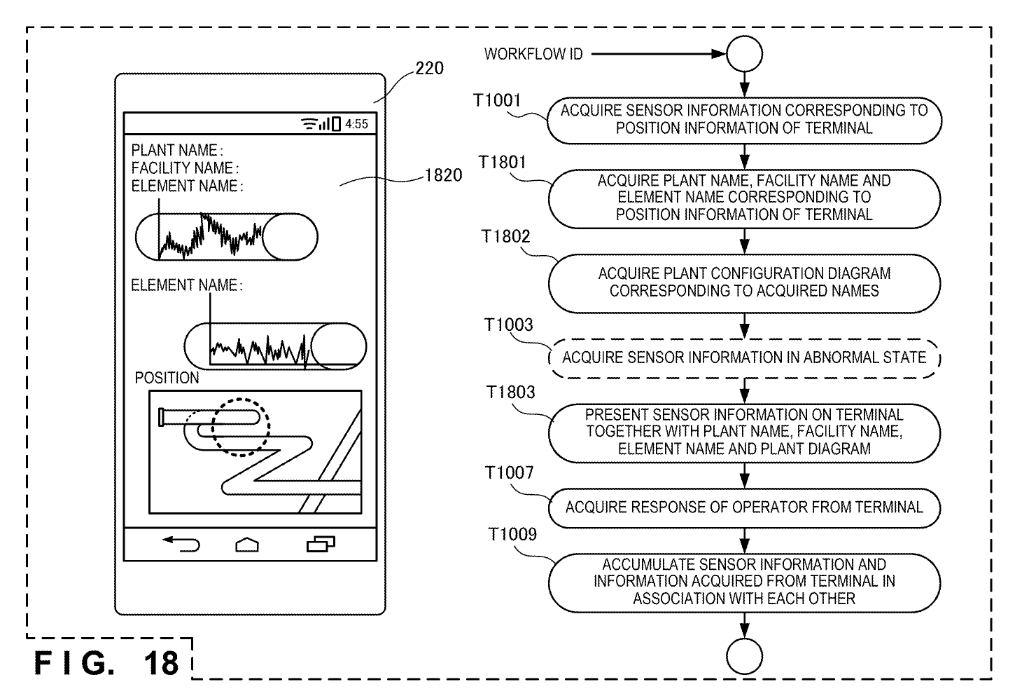

FIG. 18 is a view showing the third presentation example on work-site in the plant management system according to this example embodiment and a corresponding workflow. In the third presentation example shown in FIG. 18, a plant name, a facility name, or an element name for which sensor information is acquired is displayed together with the sensor information (for example, a graph).

The left view of FIG. 18 shows a display screen 1820 that performs not only superimposition display of the sensor information of a sensor on work-site on a plant image but also presentation of a plant name, a facility name, or an element name and, if necessary, a plant configuration diagram on work-site and an observation or inspection target portion (broken line frame) as well.

The right view of FIG. 18 shows a workflow for implementing presentation of the plant image and the sensor information shown in the left view of FIG. 18 or presentation of a plant name, a facility name, or an element name to the operator 250 on work-site. Note that the same task numbers as in FIG. 10 denote the same tasks in the right view of FIG. 18, and a repetitive description thereof will be omitted.

In task T1801, the workflow apparatus 510 acquires a plant name, facility name and element name or the like corresponding to the position information of the terminal 220 on work-site. In task T1802, the workflow apparatus 510 acquires a plant configuration diagram corresponding to the acquired names. In task T1803, the workflow apparatus 510 presents the sensor information of the sensor on work-site to the operator 250 on work-site together with the plant name, facility name, element name and the plant configuration diagram on work-site.

According to the third presentation example, it is possible to perform labeling of sensor information, a superimposed image, and sound information by a plant name, a sensor name, a pipe name, or the like, and the operator 250 can easily extract the information.

<<Fourth Presentation Example and Workflow>>

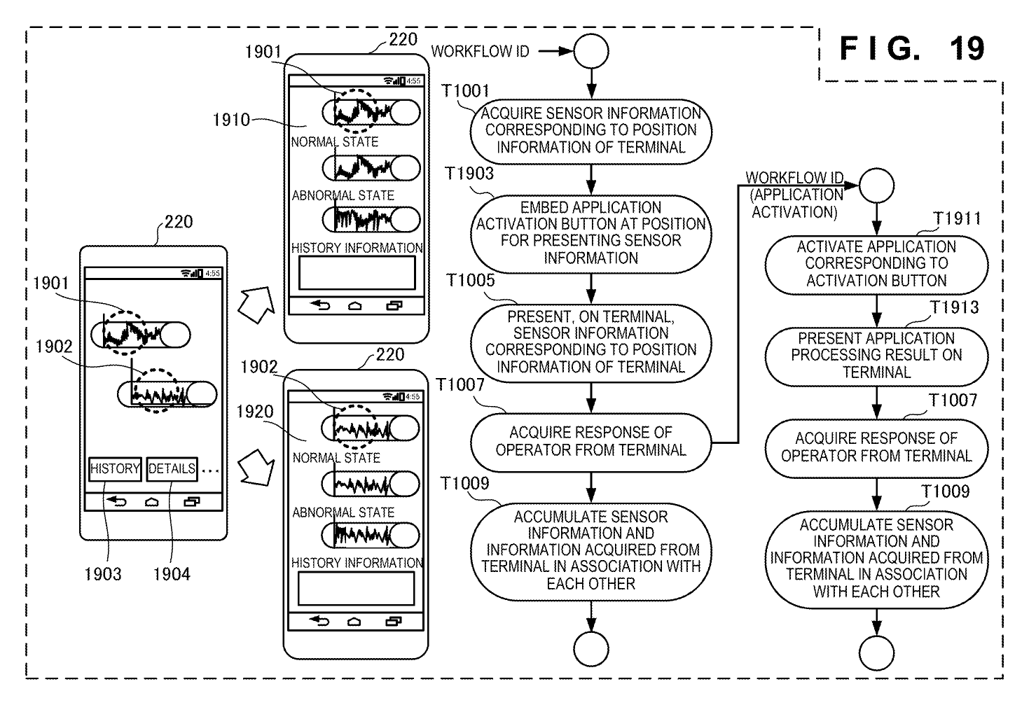

FIG. 19 is a view showing the fourth presentation example on work-site in the plant management system according to this example embodiment and a corresponding workflow. In the fourth presentation example shown in FIG. 19, the system is configured to enable jump to an external application when confirming details of sensor information (for example, a graph) or associated information.

The left view of FIG. 19 shows an example in which on the terminal 220, when sensor information 1901 or 1902 is touched, or when another display button (a history button 1903 or a detail button 1904) is touched in a state in which the sensor information of a sensor on work-site is superimposed on a plant image, jump to an external application is performed. The left view of FIG. 19 shows a display screen 1910 in a case in which the sensor information 1901 is touched, and a display screen 1920 in a case in which the sensor information 1902 is touched.

The right view of FIG. 19 shows a workflow for implementing an operation of jumping to an external application from the display of the plant image and the sensor information shown in the left view of FIG. 18. Note that the same task numbers as in FIG. 10 denote the same tasks in the right view of FIG. 19, and a repetitive description thereof will be omitted.

In task T1903, the workflow apparatus 510 embeds the activation button of an external application (or another workflow) at a position for presenting sensor information or at a predetermined button display position. Upon detecting a touch on the activation button of the external application (or the other workflow) as the response of the operator 250 on work-site in task T1007, the workflow apparatus 510 activates a new workflow to activate the external application.

In the newly activated workflow, the workflow apparatus 510 activates an external application corresponding to an activated button in task T1911. In task T1913, the workflow apparatus 510 presents the processing result of the external application on the terminal 220 on work-site.

According to the fourth presentation example, it is possible to seamlessly jump to the external application without interrupting the current sensor information presentation application.

<<Fifth Presentation Example and Workflow>>

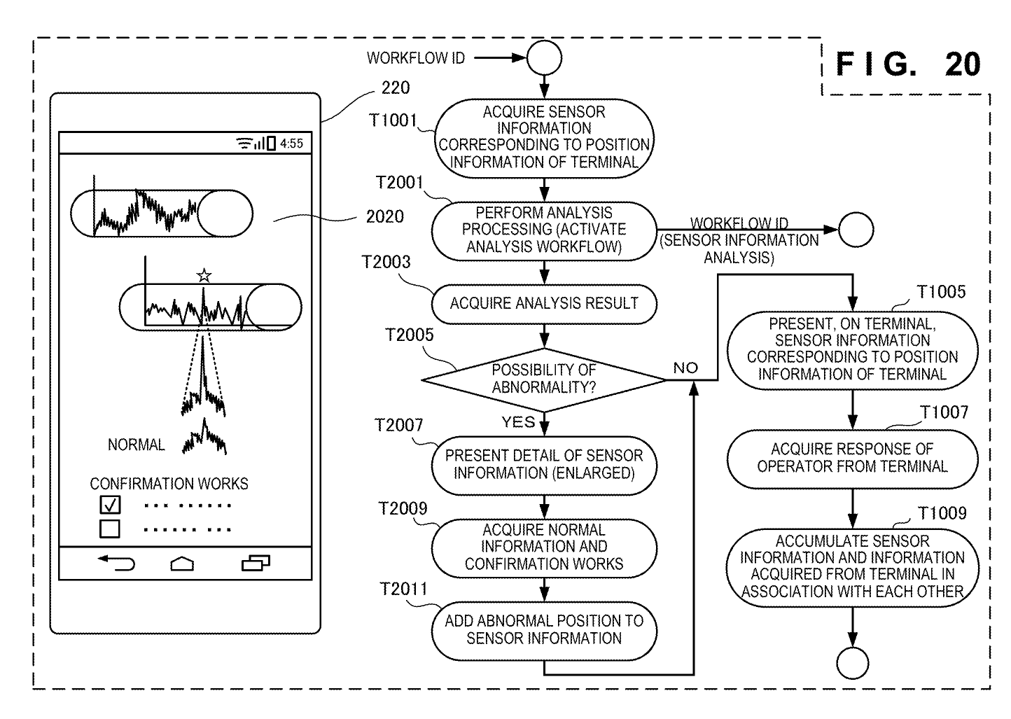

FIG. 20 is a view showing the fifth presentation example on work-site in the plant management system according to this example embodiment and a corresponding workflow. In the fifth presentation example shown in FIG. 20, a ⋆ mark is added to sensor information (for example, a graph), or the color of the sensor information is changed, thereby displaying the time of abnormal data in cooperation with an analysis engine.

In the left view of FIG. 20, on the terminal 220, in a state in which the sensor information of a sensor on work-site is superimposed on a plant image, if an abnormality is found or predicted by the analysis result of the sensor information, the point is indicated by, for example, a ⋆ mark. Additionally, in a display screen 2020 shown in FIG. 20, information in a normal state for the same sensor information and an instruction of confirmation works based on this pieces of information are presented together with detailed information representing the enlarged abnormal portion.

The right view of FIG. 20 shows a workflow for implementing an operation of instructing an abnormal point or presenting a confirmation work on the display of the plant image and the sensor information shown in the left view of FIG. 20. Note that the same task numbers as in FIG. 10 denote the same tasks in the right view of FIG. 20, and a repetitive description thereof will be omitted.

In task T2001, the workflow apparatus 510 activates an analysis workflow for analyzing the sensor information of a sensor on work-site. In task T2003, the workflow apparatus 510 acquires the analysis result of the sensor information. In task T2005, the workflow apparatus 510 determines, based on the analysis result, whether there is a possibility of abnormality in the sensor information. If there is no possibility of abnormality, the workflow apparatus 510 performs processing from task T1005.

On the other hand, if there is a possibility of abnormality, in task T2007, the workflow apparatus 510 presents details (enlargement) of the presented sensor information. In task T2009, the workflow apparatus 510 acquires sensor information in a normal state for comparison and a menu of confirmation operations necessary to confirm the abnormality or determine the cause. The menu of the confirmation operations may include new workflows. To present the abnormal point of the sensor information to the operator 250 on work-site, for example, a ⋆ mark is added.

According to the fifth presentation example, if there is a possibility of abnormality based on comprehensive analysis of sensor information, details of sensor information associated with the abnormality or a next work instruction needed to confirm the abnormality or determine the cause can be smoothly seamlessly implemented for the operator on work-site.

<<Sixth Presentation Example and Workflow>>

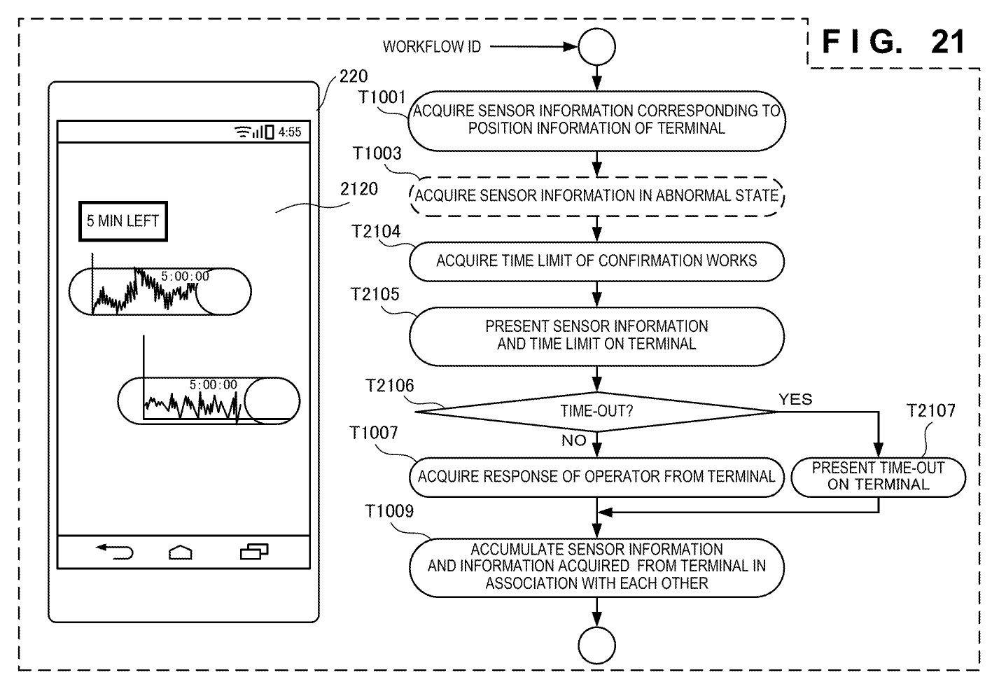

FIG. 21 is a view showing the sixth presentation example on work-site in the plant management system according to this example embodiment and a corresponding workflow. In the sixth presentation example shown in FIG. 21, when the confirmation work shown in FIG. 20 or the like is assigned as a task with a time limit, the time limit is displayed together with sensor information. In addition, the time limit time may be displayed in the presented sensor information (for example, a graph).

The left view of FIG. 21 shows a display screen 2120 that displays a time limit together with the sensor information and displays the time limit time in the presented sensor information (for example, a graph) on the terminal 220 in a state in which the sensor information of a sensor on work-site is superimposed on a plant image.

The right view of FIG. 21 shows a workflow for implementing presentation of the time limit to the operator 250 on work-site shown in the left view of FIG. 21. Note that the same task numbers as in FIG. 10 denote the same tasks in the right view of FIG. 21, and a repetitive description thereof will be omitted.

In task T2104, the workflow apparatus 510 acquires the time limit of the confirmation work. In task T2105, the workflow apparatus 510 presents the sensor information and the time limit on the terminal 220 on work-site, as shown in the left view. In task T2106, the workflow apparatus 510 determines whether the time limit is exceeded. If the time limit on the terminal 220 is not exceeded, the workflow apparatus 510 executes processing from task T1007. If the time limit on the terminal 220 is exceeded, in task T2107, the workflow apparatus 510 presents that the time limit of the confirmation work is exceeded on the terminal 220 on work-site.

According to the sixth presentation example, it is possible to urge the operator 250 on work-site to complete the confirmation work within the time.

<<Seventh Presentation Example and Workflow>>

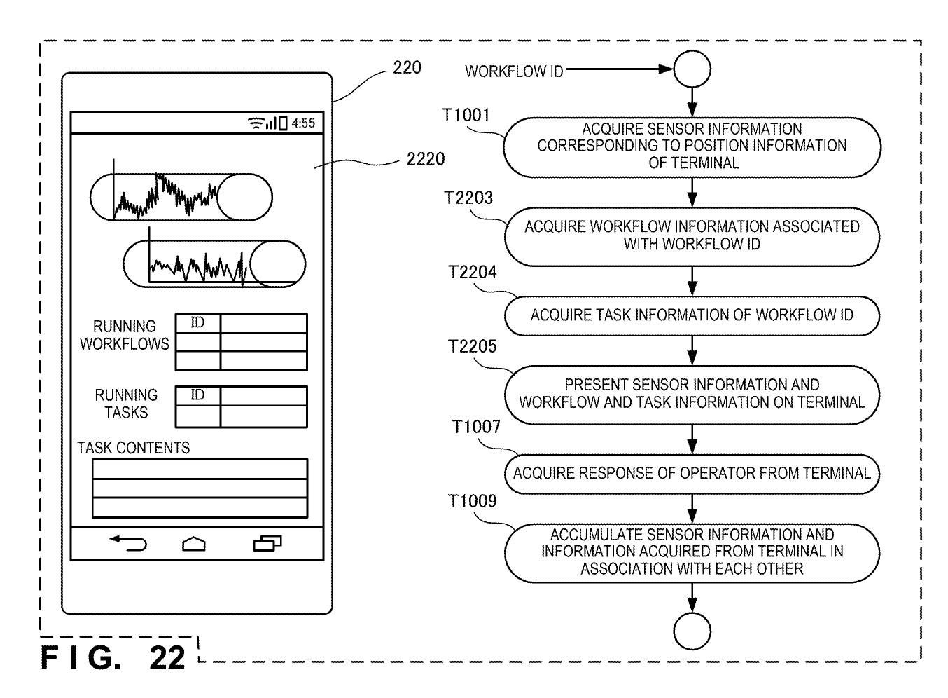

FIG. 22 is a view showing the seventh presentation example on work-site in the plant management system according to this example embodiment and a corresponding workflow.

In the seventh presentation example shown in FIG. 22, a description about a task that is currently being executed or a description of a workflow including the task is presented together with sensor information (for example, a graph). For example, “specify the cause of abnormal noise from the point”, “confirm ◯◯”, “the method of a procedure xxx”, “matters taken over from a predecessor”, or the like may be presented. Note that if the instruction is displayed as a workflow chart, the workflow can more visually be understood.

The left view of FIG. 22 shows a display screen 2220 that displays a workflow that is being executed, the information of a task, and the contents of a task including the role of the task in a state in which the sensor information of a sensor on work-site is superimposed on a plant image on the terminal 220.

The right view of FIG. 22 shows a workflow for presenting a workflow, the information of a task, and the contents of a task including the role of the task to the operator 250 on work-site shown in the left view of FIG. 22. Note that the same task numbers as in FIG. 10 denote the same tasks in the right view of FIG. 22, and a repetitive description thereof will be omitted.

In task T2203, the workflow apparatus 510 acquires workflow information associated with a workflow ID. In task T2204, the workflow apparatus 510 acquires the task information of the workflow ID. Then, in task T2205, the workflow apparatus 510 presents the sensor information, the workflow, and the task information for the terminal 220 on work-site to the operator 250 on work-site.

According to the seventh presentation example, a history, a place, or the like, which is the positioning of the current workflow, is presented in detail to the operator on work-site, thereby causing the operator on work-site to recognize the meaning of a work.

<<Eighth Presentation Example and Workflow>>

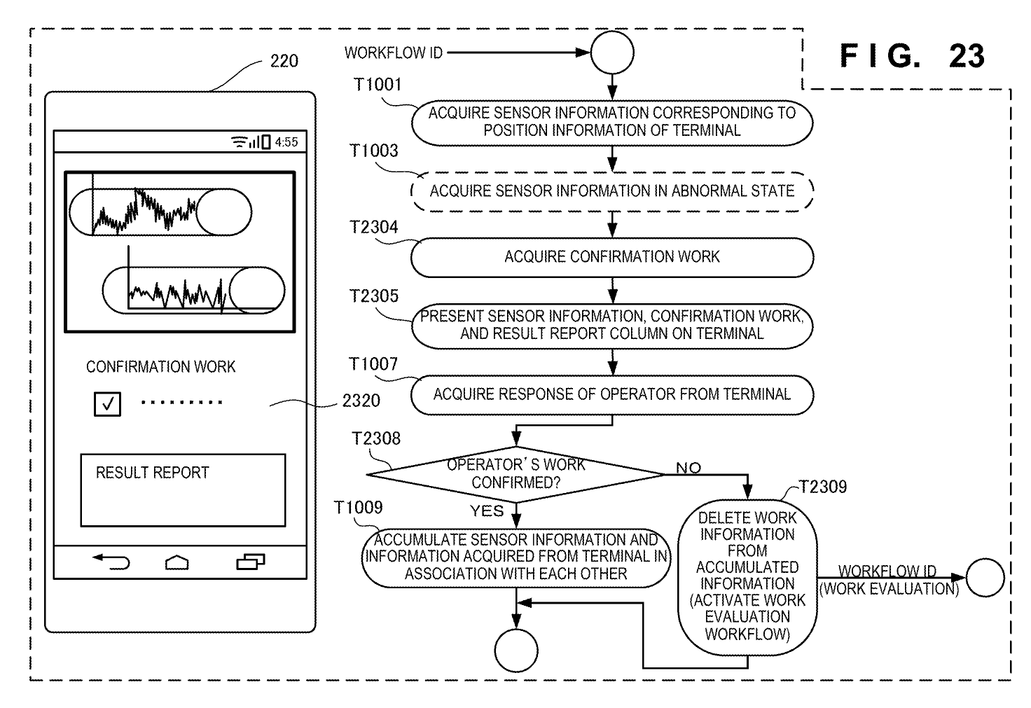

FIG. 23 is a view showing the eighth presentation example on work-site in the plant management system according to this example embodiment and a corresponding workflow. In the eighth presentation example shown in FIG. 23, for example, an image captured by the terminal 220 is sent to the management center as the evidence of actual observation and confirmation of the site by the operator. The image to be sent to the management center can be either a still image or a moving image.

The left view of FIG. 23 shows a screen 2320 in which a plant image on work-site captured by the camera of the terminal 220 carried by the operator 250 on work-site is transmitted to the management center together with a confirmation work or result report of the operator 250 on work-site in a state in which the sensor information of a sensor on work-site is superimposed on a plant image on the terminal 220.

The right view of FIG. 23 shows a workflow for transmitting the plant image on work-site captured by the camera of the terminal 220 carried by the operator 250 on work-site to the management center together with the confirmation work or result report of the operator 250 on work-site shown in the left view of FIG. 23. Note that the same task numbers as in FIG. 10 denote the same tasks in the right view of FIG. 23, and a repetitive description thereof will be omitted.

In task T2304, the workflow apparatus 510 acquires a confirmation work to be presented to the operator 250 on work-site. In task T2305, the workflow apparatus 510 presents the sensor information, the confirmation work, and a result report column on the terminal 220.

When a response from the operator 250 on work-site is acquired, in task T2308, the workflow apparatus 510 confirms the work of the operator. To confirm the work of the operator, for example, an image of the site captured by the camera of the terminal 220 is used. If the work of the operator is questionable, in task T2309, the workflow apparatus 510 deletes the confirmation work result or report from the accumulated information and activates an operator work evaluation workflow.

According to the eighth presentation example, since the work by the operator on work-site can be confirmed, incorrect information can be excluded from monitoring or analysis processing of plant management, and more reliable plant management can be implemented.

<<Ninth Presentation Example and Workflow>>

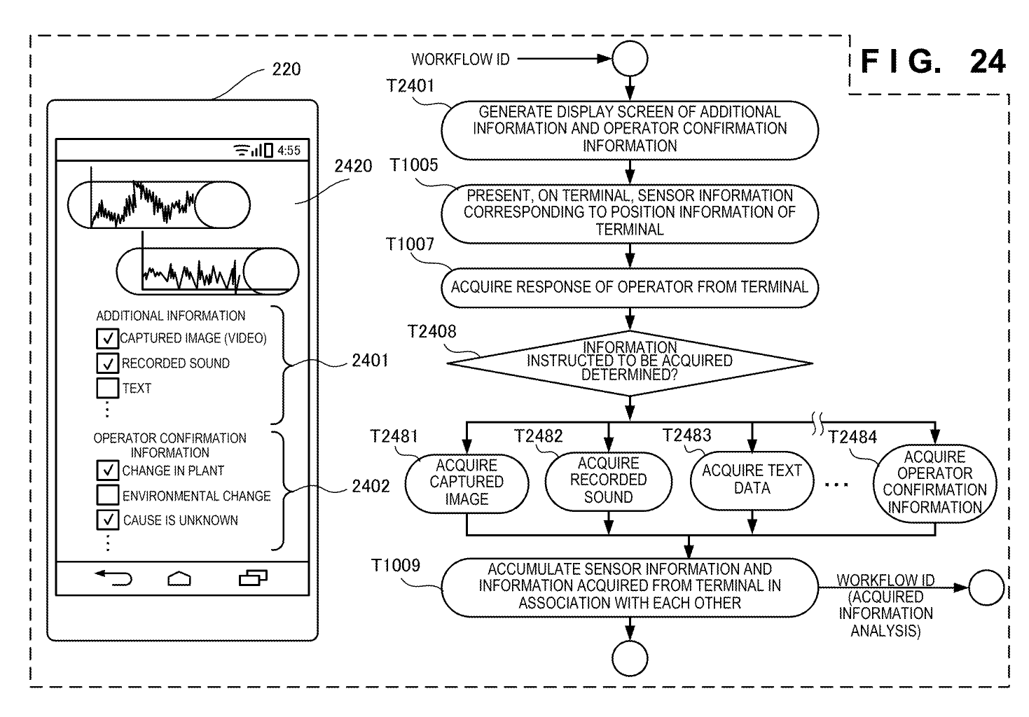

FIG. 24 is a view showing the ninth presentation example on work-site in the plant management system according to this example embodiment and a corresponding workflow.

In the ninth presentation example shown in FIG. 24, buttons used by the operator 250 on work-site to report a work result are presented together with sensor information (for example, a graph). The presentation method is not limited to buttons and may be a menu or the like. After a button is pressed, an opportunity of detail input (text input, registration of capturing captured image result, or registration of recorded data) such as a text, a photo, or a sound may be given to cause the operator to make a report there. If a captured image is superimposed on the sensor information, this may be used as a report material. In addition, a function (for example, a button) of explicitly showing “the cause is unknown” may be provided. Transmission of the information to the manager by the operator is useful per se.

The left view of FIG. 24 shows a screen 2420 that presents an addition instruction 2401 of information such as text input, registration of captured image result, or registration of recorded data and a confirmation instruction 2402 to know the situation on work-site by the operator 250 on work-site in a state in which the sensor information of a sensor on work-site is superimposed on a plant image on the terminal 220.

The right view of FIG. 24 shows a workflow for acquiring more detailed associated information or the confirmation information of the operator 250 on work-site in addition to the confirmation work or result report of the operator 250 on work-site shown in the left view of FIG. 24. Note that the same task numbers as in FIG. 10 denote the same tasks in the right view of FIG. 24, and a repetitive description thereof will be omitted.

In task T2401, the workflow apparatus 510 generates a display screen of additional information and operator confirmation information. In task T2408, the workflow apparatus 510 determines an information instructed to be further acquired. In task T2481, according to the determination result, the workflow apparatus 510 acquires an image of the plant captured by the camera of the terminal 220. Additionally, in task T2482, the workflow apparatus 510 acquires a sound near the plant. In addition, in task T2483, the workflow apparatus 510 acquires text data input by the operator 250 on work-site. Furthermore, in task T2484, the workflow apparatus 510 acquires confirmation information inquired of the operator 250 on work-site.

According to the ninth presentation example, since information collection necessary for plant management from the operator is actively performed, the plant state can more correctly be recognized.

<<10th Presentation Example and Workflow>>

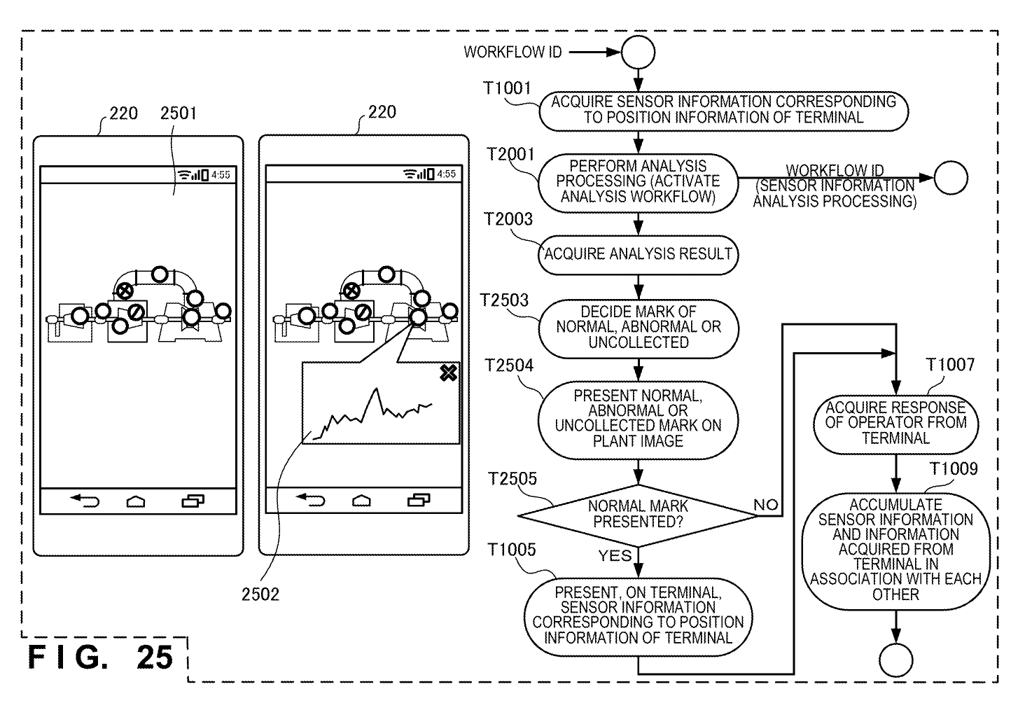

FIG. 25 is a view showing the 10th presentation example on work-site in the plant management system according to this example embodiment and a corresponding workflow.

In the 10th presentation example shown in FIG. 25, when the operator taps on the plant configuration diagram of a site, a mark “◯” to display the sensor information of a sensor installed at that position is displayed. In addition, a mark “x” (inside ◯ in FIG. 25) is displayed at the position of a sensor determined to have abnormality. Furthermore, a mark “/” (inside ◯ in FIG. 25) is displayed at the position of a sensor whose sensor information cannot be viewed due to some reason, for example, because the sensor information is not collected, or collection has failed because of a communication error.

The left view of FIG. 25 shows a display screen 2501 of the plant configuration diagram of the site and a screen 2502 on which sensor information is displayed when one mark “◯” is tapped on the terminal 220.

The right view of FIG. 25 shows a workflow for implementing presentation of marks on the plant configuration diagram and processing when a mark is instructed in the left view of FIG. 25. Note that the same task numbers as in FIG. 10 or 20 denote the same tasks in the right view of FIG. 25, and a repetitive description thereof will be omitted.

In task T2503, the workflow apparatus 510 decides the mark of normal, abnormal or uncollected of sensor information. In task T2504, the workflow apparatus 510 presents the normal/abnormal/uncollected marks superimposed on a plant image. In task T2505, the workflow apparatus 510 determines whether the operator 250 on work-site has tapped a mark representing a normal state. If the operator has tapped a mark representing a normal state, sensor information is presented. If the operator has tapped a mark other than the marks of the normal state, sensor information is not presented.

According to the 10th presentation example, sensor information is presented according to the intention of the operator on work-site and, for example, efficient observation and inspection history can be taken over from the inspection history of the sensor information of a skillful operator.

<<11th Presentation Example and Workflow>>

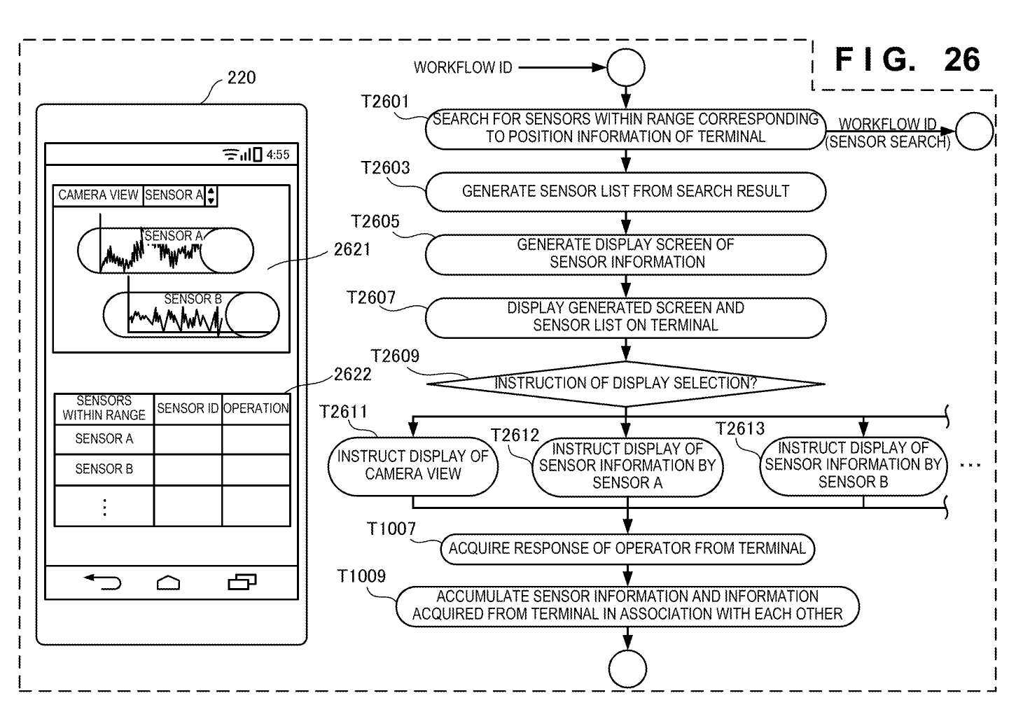

FIG. 26 is a view showing the 11th presentation example on work-site in the plant management system according to this example embodiment and a corresponding workflow.

In the 11th presentation example shown in FIG. 26, the list of sensors existing in the plant as the target of a site in the ninth presentation example is displayed in a superimposed manner. As for the list of sensors, a predetermined range is determined from the data of the GPS of the terminal 220 carried by the operator 250, and plant configuration data is searched for and generated and dynamically updated.

The left view of FIG. 26 shows a screen including a display screen 2621 of a plant image and sensor information and a sensor list 2622 on the terminal 220.

The right view of FIG. 26 shows a workflow for presenting the screen including the display screen 2621 of the plant image and the sensor information and the sensor list 2622 and selecting display in the left view of FIG. 26. Note that the same task numbers as in FIG. 10 denote the same tasks in the right view of FIG. 26, and a repetitive description thereof will be omitted.

In task T2601, the workflow apparatus 510 activates a workflow of sensor search for searching for sensors within a range corresponding to the position information of the terminal. In task T2603, the workflow apparatus 510 generates the sensor list 2622 based on the sensor search result. In task T2605, the workflow apparatus 510 generates the display screen 2621 of sensor information. In task T2607, the workflow apparatus 510 presents the display screen 2621 and the sensor list 2622 on the terminal 220 on work-site.

In task T2609, the workflow apparatus 510 determines the instruction of display selection. In task T2611, the workflow apparatus 510 instructs display of the camera view of the terminal 220 on the display screen 2621 in accordance with the instruction of display selection. Additionally, in task T2612, the workflow apparatus 510 instructs display of the sensor information of a sensor A on the display screen 2621. Furthermore, in task T2613, the workflow apparatus 510 instructs display of the sensor information of a sensor B on the display screen 2621.

According to the 11th presentation example, pieces of sensor information of sensors within a predetermined range can be selected from the data of the GPS of the terminal carried by the operator 250 and presented.

<<12th Presentation Example and Workflow>>

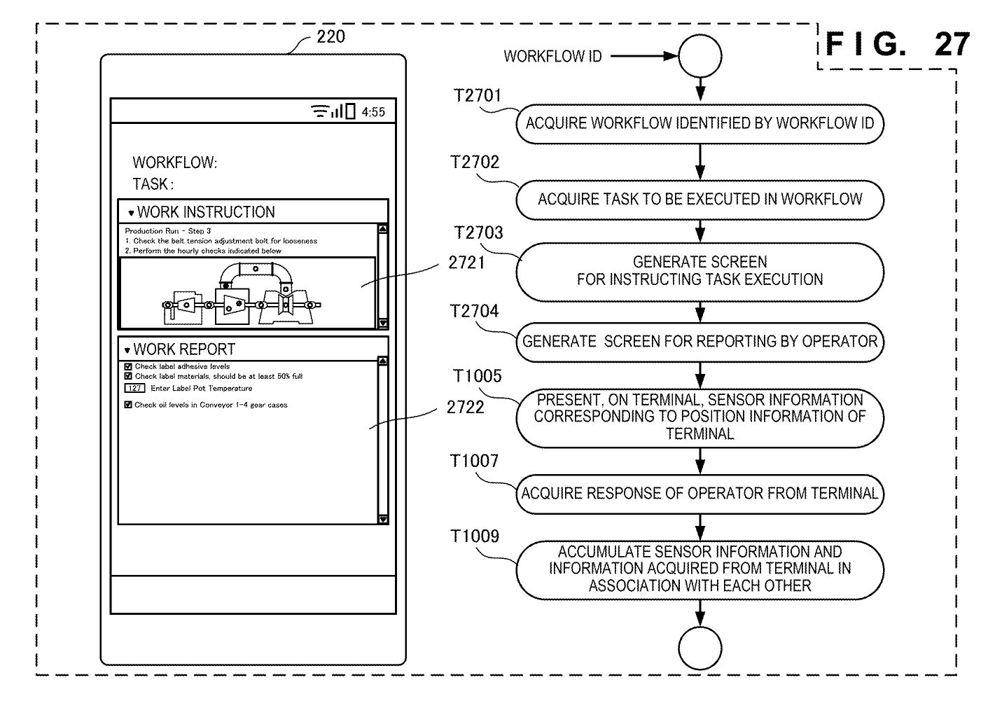

FIG. 27 is a view showing the 12th presentation example on work-site in the plant management system according to this example embodiment and a corresponding workflow.

In the 12th presentation example shown in FIG. 27, a task management screen in a workflow management screen in the management center of a plant is presented on the terminal 220 carried by the operator 250 on work-site to successively manage the work of the operator 250 on work-site, and information of the operator 250 on work-site is quickly collected and reflected on plant management.

The left view of FIG. 27 shows a screen including a work instruction screen 2721 and a work report 2722, in which a task management screen in a workflow management screen in the management center of a plant is presented on the terminal 220 carried by the operator 250 on work-site on the terminal 220.

The right view of FIG. 27 shows a workflow for causing the operator 250 on work-site and the management center to implement quick communication by the screen including the work instruction screen 2721 and the work report 2722 shown in the left view of FIG. 27. Note that the same task numbers as in FIG. 10 denote the same tasks in the right view of FIG. 27, and a repetitive description thereof will be omitted.

In task T2701, the workflow apparatus 510 acquires the workflow identified by a workflow ID. In task T2702, the workflow apparatus 510 acquires a task to be executed in the workflow. In task T2703, the workflow apparatus 510 generates a screen (work instruction screen 2721) for instructing task execution. In task T2704, the workflow apparatus 510 generates a screen (work report screen 2722) for reporting by the operator 250.

According to the 12th presentation example, efficient plant management can be performed by fusing the work of the operator on work-site and plant management.

According to this example embodiment, since a contrivance is made for the sensor information presentation method and the method of acquiring associated information from the operator, it is possible to more efficiently support the on-site work of the operator who checks or maintains a structure such as a plant.

### Fifth Example Embodiment

A plant management system according to the fifth example embodiment of the present invention will be described next. The plant management system according to this example embodiment is different from the above-described second to fourth example embodiments in that a terminal has a superimposition display function and a projection function for sensor information. The rest of the components and operations is the same as in the second example embodiment. Hence, the same reference numerals denote the same components and operations, and a detailed description thereof will be omitted.

<<Plant Management System>>

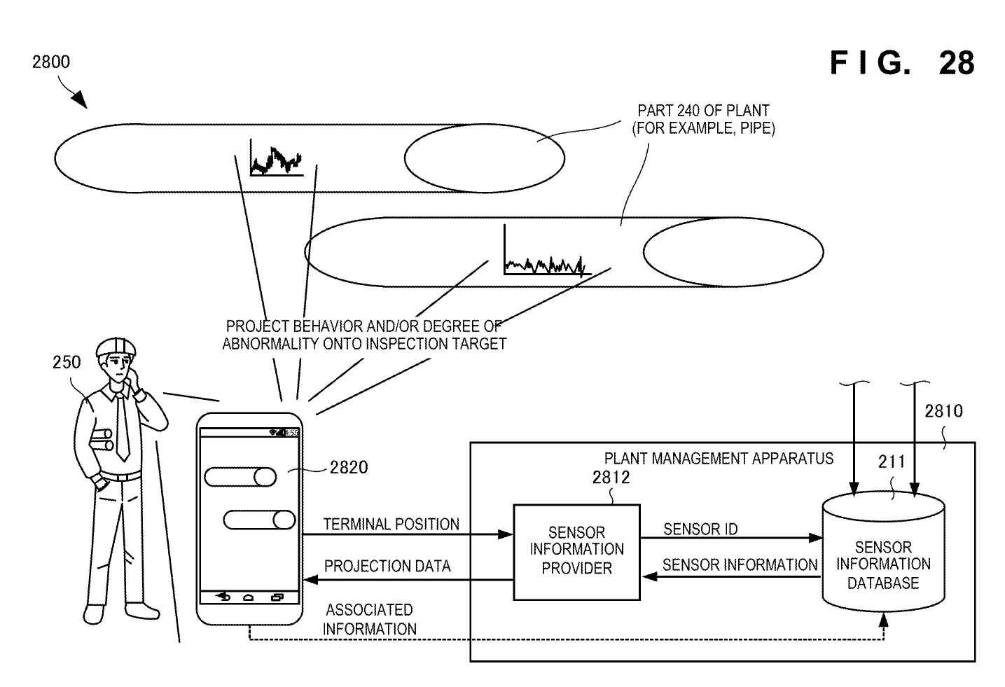

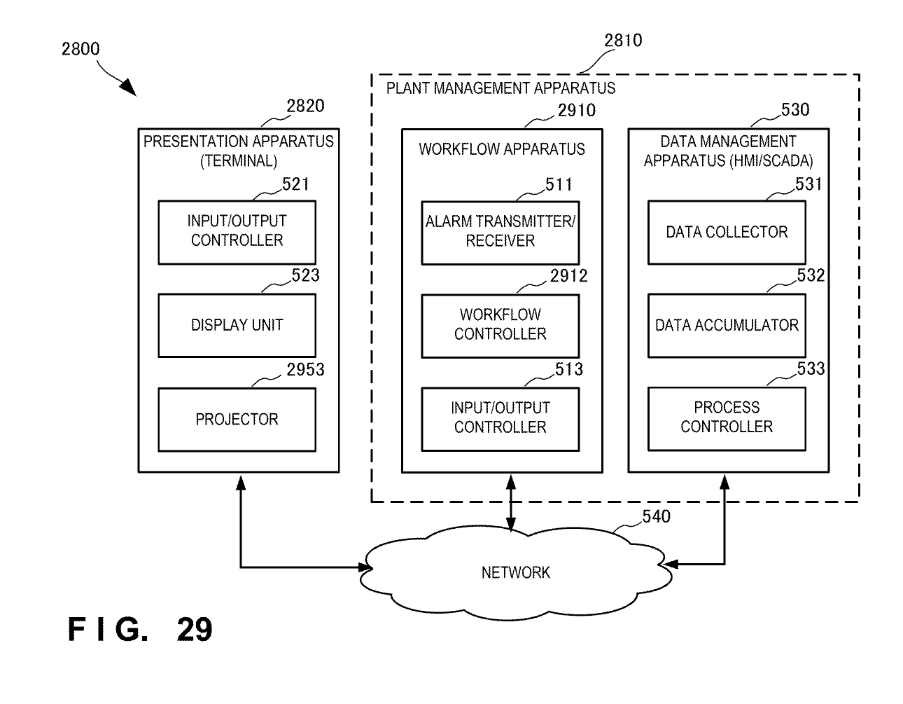

The arrangement and operation of a plant management system 2800 according to this example embodiment will be described with reference to FIGS. 28 and 29.

(Operation Outline)

FIG. 28 is a view showing the operation outline of the plant management system 2800 according to this example embodiment. Note that the same reference numerals as in FIG. 2A or FIGS. 11A and 11B denote the same constituent elements in FIG. 28, and a repetitive description thereof will be omitted.

Referring to FIG. 28, a plant management apparatus 2810 includes a sensor information provider 2812. When current position information is acquired from a terminal 2820 carried by an operator 250 on work-site, the sensor information provider 2812 selects a corresponding sensor and projects the sensor information of the sensor to a part 240 of a plant on which the sensor is set using the projection function of the terminal 2820.

(Hardware Arrangement)

FIG. 29 is a block diagram showing the hardware arrangement of the plant management system 2800 according to this example embodiment. Note that the same reference numerals as in FIG. 5A or 13 denote the same constituent elements in FIG. 29, and a repetitive description thereof will be omitted.

The plant management system 2800 includes the plant management apparatus 2810 and the terminal 2820 serving as a presentation apparatus, which are connected via a network 540. A workflow apparatus 2910 that constitutes the plant management apparatus 2810 activates a workflow for causing a projector 2953 of the terminal 2820 as the presentation apparatus according to this example embodiment to project sensor information.

On the other hand, the projector 2953 of the terminal 2820 projects the sensor information of a sensor corresponding to the current position information of the terminal 2820 or an image in which the sensor information is superimposed on a plant image to the plant in which the sensor corresponding to the current position information is installed or a screen.

According to this example embodiment, it is possible to project sensor information without arranging a projector serving as a projection apparatus having a projection function on work-site. It is therefore possible to efficiently support the on-site work of the operator who checks or maintains a structure such as a plant while suppressing the facility investment.

### Other Example Embodiments

While the invention has been particularly shown and described with reference to example embodiments thereof, the invention is not limited to these example embodiments. It will be understood by those of ordinary skill in the art that various changes in form and details may be made therein without departing from the spirit and scope of the present invention as defined by the claims.

The present invention is applicable to a system including a plurality of devices or a single apparatus. The present invention is also applicable even when a plant management program for implementing the functions of example embodiments is supplied to the system or apparatus directly or from a remote site. Hence, the present invention also incorporates the program installed in a computer to implement the functions of the present invention by the computer, a medium storing the program, and a WWW (World Wide Web) server that causes a user to download the program. Especially, the present invention incorporates at least a non-transitory computer readable medium storing a program that causes a computer to execute processing steps included in the above-described example embodiments.

### Other Expressions of Example Embodiments

Some or all of the above-described embodiments can also be described as in the following supplementary notes but are not limited to the followings.

(Supplementary Note 1)

There is provided a plant management system comprising:

a position acquirer that acquires a position of a terminal;

a sensor specifier that specifies a sensor in accordance with the position of the terminal;

a sensor information acquirer that acquires sensor information concerning the specified sensor; and

a presenter that presents the sensor information to an operator by superimposing or projecting the sensor information in association with a target to be measured by the specified sensor.

(Supplementary Note 2)

In the plant management system according to supplementary note 1, the presenter comprises a superimposing display unit that displays the sensor information superimposed in association with the target to be measured by the specified sensor using an augmented reality technology.

(Supplementary Note 3)

In the plant management system according to supplementary note 1 or 2, the presenter comprises a projection device that projects the sensor information in association with the target to be measured by the specified sensor.

(Supplementary Note 4)

In the plant management system according to supplementary note 1 or 3, the target to be measured by the specified sensor corresponds to a position in which the specified sensor is installed.

(Supplementary Note 5)

In the plant management system according to supplementary note 1 or 4, the position acquirer is a unit that acquires the position using a global positioning system.

(Supplementary Note 6)

In the plant management system according to supplementary note 1 or 5, the position acquirer includes an image capturer, and acquires the position by analyzing an image captured by the image capturer.

(Supplementary Note 7)

In the plant management system according to supplementary note 1 or 6, the sensor specifier further comprises an abnormal sensor determiner that determines abnormal sensors, and specifies the sensor from the abnormal sensors based on the position.

(Supplementary Note 8)

In the plant management system according to supplementary note 1 or 7, the position acquired by the position acquirer is a position at which abnormality is detected, and

the sensor specifier specifies the sensor based on the position which is acquired by the position acquirer and at which the abnormality is detected.

(Supplementary Note 9)

The plant management system according to supplementary note 1 or 8, further comprises:

a storage unit that stores associated information which is associated with the specified sensor and acquired by the terminal based on an operation of the operator; and

an accumulator that accumulates the sensor information and the associated information in association with each other.

(Supplementary Note 10)

The plant management system according to supplementary note 9, further comprising a predictor that predicts an operation state of the target to be measured based on a correspondence between the sensor information and the associated information accumulated in the accumulator.

(Supplementary Note 11)

There is provided a plant management method comprising:

acquiring a position of a terminal;

specifying a sensor in accordance with the acquired position;

acquiring sensor information concerning the specified sensor; and

presenting the sensor information to an operator by superimposing or projecting the sensor information in association with a target to be measured by the specified sensor.

(Supplementary Note 12)

There is provided a plant management apparatus comprising:

a position acquirer that acquires a position of a terminal carried by an operator;

a sensor specifier that specifies a sensor in accordance with the acquired position;

a sensor information acquirer that acquires sensor information concerning the specified sensor; and

an instructor that instructs to present the sensor information to the operator by superimposing or projecting the sensor information in association with a target to be measured by the specified sensor.

(Supplementary Note 13)

In the plant management apparatus according to supplementary note 12, the instructor instructs a superimposing display unit that displays the sensor information superimposed in association with the target to be measured by the specified sensor to present the sensor information to the operator using an augmented reality technology.

(Supplementary Note 14)

In the plant management apparatus according to supplementary notes 12 or 13, the instructor instructs a projection device that projects the sensor information in association with the target to be measured by the specified sensor to present the sensor information to the operator.

(Supplementary Note 15)

There is provided a plant management program for causing a computer to execute a method comprising:

displaying a list of tasks to be performed by an operator on a terminal which is carried by the operator, after login from the terminal;

acquiring a position of the terminal; and

instructing to present sensor information concerning a sensor specified in accordance with the acquired position to the operator by superimposing or projecting the sensor information in association with a target to be measured by the specified sensor.

(Supplementary Note 16)

In the plant management program according to supplementary notes 15, the plant management program causes the computer to further execute receiving associated information which is associated with the specified sensor and acquired by the terminal based on an operation of the operator.

(Supplementary Note 17)

There is provided a plant management program for causing a computer to execute a method comprising:

acquiring a position of a terminal which is carried by an operator, after login from the terminal;

specifying a sensor in accordance with the acquired position;

acquiring sensor information concerning the specified sensor; and

generating presentation information to be presented to the operator by superimposing or projecting the sensor information in association with a target to be measured by the specified sensor.

(Supplementary Note 18)

In the plant management program according to supplementary notes 17, the plant management program causes the computer to further execute:

instructing to present the presentation information to the operator; and

acquiring associated information which is associated with one of the specified sensor and the presentation information and acquired by the terminal based on an operation of the operator.

(Supplementary Note 19)

There is provided a plant management program for causing a computer to execute a method comprising:

acquiring sensor information concerning a sensor specified in accordance with a position of a terminal which is carried by an operator, after login from the terminal;

acquiring associated information acquired by the terminal in association with the specified sensor; and

accumulating the sensor information and the associated information in an accumulator in association with each other.

(Supplementary Note 20)

In the plant management program according to supplementary notes 19, the plant management program causes the computer to further execute predicting an operation state of a target to be measured by the sensor based on a correspondence between the sensor information and the associated information.

1. A plant management system comprising:
a position acquirer that acquires a position of a terminal;
a sensor specifier that specifies a sensor in accordance with the position of the terminal;
a sensor information acquirer that acquires sensor information concerning the specified sensor; and
a presenter that presents the sensor information to an operator by superimposing or projecting the sensor information in association with a target to be measured by the specified sensor.

2. The plant management system according to claim 1, wherein the presenter comprises a superimposing display unit that displays the sensor information superimposed in association with the target to be measured by the specified sensor using an augmented reality technology.

3-5. (canceled)

6. The plant management system according to claim 1, wherein the position acquirer includes an image capturer, and acquires the position by analyzing an image captured by the image capturer.

7. The plant management system according to claim 1, wherein the sensor specifier further comprises an abnormal sensor determiner that determines abnormal sensors, and specifies the sensor from the abnormal sensors based on the position.

8. The plant management system according to claim 1, wherein the position acquired by the position acquirer is a position at which abnormality is detected, and
the sensor specifier specifies the sensor based on the position which is acquired by the position acquirer and at which the abnormality is detected.

9. The plant management system according to claim 1, further comprising:
a storage unit that stores associated information which is associated with the specified sensor and acquired by the terminal based on an operation of the operator; and
an accumulator that accumulates the sensor information and the associated information in association with each other.

10. The plant management system according to claim 9, further comprising a predictor that predicts an operation state of the target to be measured based on a correspondence between the sensor information and the associated information accumulated in the accumulator.

11. (canceled)

12. A plant management apparatus comprising:
a position acquirer that acquires a position of a terminal carried by an operator;
a sensor specifier that specifies a sensor in accordance with the acquired position;
a sensor information acquirer that acquires sensor information concerning the specified sensor; and
an instructor that instructs to present the sensor information to the operator by superimposing or projecting the sensor information in association with a target to be measured by the specified sensor.

13. The plant management apparatus according to claim 12, wherein the instructor instructs a superimposing display unit that displays the sensor information superimposed in association with the target to be measured by the specified sensor to present the sensor information to the operator using an augmented reality technology.

14. The plant management apparatus according to claim 12, wherein the instructor instructs a projection device that projects the sensor information in association with the target to be measured by the specified sensor to present the sensor information to the operator.

15. A non-transitory computer-readable storage medium storing a plant management program for causing a computer to execute a method comprising:
displaying a list of tasks to be performed by an operator on a terminal which is carried by the operator, after login from the terminal;
acquiring a position of the terminal; and
instructing to present sensor information concerning a sensor specified in accordance with the acquired position to the operator by superimposing or projecting the sensor information in association with a target to be measured by the specified sensor.

16. The non-transitory computer-readable storage medium according to claim 15, wherein the plant management program causes the computer to further execute receiving associated information which is associated with the specified sensor and acquired by the terminal based on an operation of the operator.

17. The non-transitory computer-readable storage medium according to claim 15, wherein the plant management program causes the computer to execute instructing to present sensor information by:
specifying a sensor in accordance with the acquired position;
acquiring sensor information concerning the specified sensor; and
generating presentation information to be presented to the operator by superimposing or projecting the sensor information in association with a target to be measured by the specified sensor.

18. The non-transitory computer-readable storage medium according to claim 17, wherein the plant management program causes the computer to further execute:
acquiring associated information which is associated with one of the specified sensor and the presentation information and acquired by the terminal based on an operation of the operator.

19. The non-transitory computer-readable storage medium according to claim 15, wherein the plant management program causes the computer to execute instructing to present sensor information by:
acquiring sensor information concerning a sensor specified in accordance with a position of a terminal which is carried by an operator, after login from the terminal;
acquiring associated information acquired by the terminal in association with the specified sensor; and
accumulating the sensor information and the associated information in an accumulator in association with each other.

20. The non-transitory computer-readable storage medium according to claim 19, wherein the plant management program causes the computer to further execute predicting an operation state of a target to be measured by the sensor based on a correspondence between the sensor information and the associated information.

21. The plant management system according to claim 7, wherein the position acquired by the position acquirer is a position at which abnormality is detected, and
the sensor specifier specifies the sensor based on the position which is acquired by the position acquirer and at which the abnormality is detected.

22. The plant management system according to claim 7, further comprising:
a storage unit that stores associated information which is associated with the specified sensor and acquired by the terminal based on an operation of the operator; and
an accumulator that accumulates the sensor information and the associated information in association with each other.

23. The plant management system according to claim 22, further comprising a predictor that predicts an operation state of the target to be measured based on a correspondence between the sensor information and the associated information accumulated in the accumulator.
